(19) United States
(12) Patent Application Publication
(10) Pub. No.: US 2026/0226376 A1
(43) Pub. Date: Aug. 6, 2026

(54) BIODEGRADABLE PERFUME COMPOSITION

(71) Applicant: GIVAUDAN SA, VERNIER (CH)

(72) Inventors: Nicolas ANORGA, Argenteuil (FR); Aurelie FERRY, Argenteuil (FR); Maxence MOUTTE, Argenteuil (FR); Anne-Sylvie SELEZNEFF, Argenteuil (FR)

(21) Appl. No.: 19/149,989

(22) PCT Filed: Jan. 23, 2024
(86) PCT No.: PCT/EP2024/051502

§ 371 Date: Jul. 22, 2025

(30) Foreign Application Priority Data
Jan. 24, 2023 (EP) 23153063.5

(51) Int. Cl. C11D 3/50; C11D 1/06; C11D 3/20

(52) U.S. Cl. CPC C11D 3/50; C11D 1/06; C11D 3/2027; C11D 3/2034; C11D 3/2068; C11D 3/2072; C11D 3/2093; C11D 3/2096

(57) ABSTRACT

The present invention relates to biodegradable perfume compositions, consumer products containing the compositions, methods of preparing the foregoing, and to methods of enhancing the performance and olfactive diversity of biodegradable perfume compositions.

The present invention relates to biodegradable perfume compositions, consumer products containing the compositions, methods of preparing the foregoing, and to methods of enhancing the performance and olfactive diversity of biodegradable perfume compositions.

### BACKGROUND OF THE INVENTION

For decades, perfumery has evolved concomitantly with the development of new, synthetic molecules having the advantages over natural odorants of a superior performance to cost ratio and/or new, original odours. This has allowed a formidable diversification of the perfumer's pallet and a considerable broadening of the creative olfactive landscape. This evolution has been possible because of access to petrochemical building blocks and by the appearance in certain cases of non-biodegradable perfumery raw materials. Although some of these synthetic materials can be prepared using renewable feedstocks, the proportion of biodegradable ingredients or ingredients formed using renewable carbon in these raw materials is not in step with current consumer trend for products with a strong ecological footprint.

Although replacing modern perfumery raw materials by natural molecules is possible, such an option would dramatically limit the creative space of the perfumer. Furthermore, most molecules from nature have a limited olfactive performance, meaning that very large volumes of such molecules would be necessary to cover the needs of today consumers, at constant olfactive performance. This means that a significant proportion of agricultural land and crop production would have to be given over to the production of such molecules, leading to monocultures and reducing precious nutritional resources. Such a solution is not sustainable.

WO 2020/094,550 discloses fragrance compositions having optimal balance of natural origin, biodegradability, energy balance and raw material procurement rules. However, this document does not offer any guidance as to how to obtain highly performing perfumes in a broad range of odour directions.

Using natural raw materials, in the sense of norm ISO 9235, such as essential oils, terpenes, terpene alcohols, vanillin, anethole and estragol may appear as a straightforward solution to this problem, but is very limitative in terms of odor palette and odor strength.

### SUMMARY OF THE INVENTION

It is an object of the invention to address the short-comings in the prior art and provide biodegradable perfume compositions that still deliver excellent olfactive performance, in particular in terms of high odour strength and diversity, by selecting for use and combining perfumery ingredients that are not only biodegradable and renewable, or partially renewable, but that can either alone or in combination replace highly performant, but poorly biodegradable perfumery ingredients without substantially affecting olfactive performance in the sense that a human subject with normal olfactive acuity would have difficulty in differentiating the olfactive character of a biodegradable perfume composition formed according to the invention from a state of the art perfume composition containing high levels of poorly biodegradable ingredients.

In a first aspect, the present invention provides a biodegradable perfume composition comprising one or more Group A ingredients; optionally one or more Group B ingredients, and which composition is free or is substantially free of Group C ingredients, wherein Group A, Group B and Group C ingredients are defined herein below.

In a second aspect the invention provides a method of preparing the biodegradable perfume composition.

In a third aspect the invention provides the use of Group A ingredients and optionally Group B ingredients, in the absence, or substantially in the absence, of Group C ingredients to enhance the olfactive performance of a biodegradable perfume composition.

In a fourth aspect the invention provides a consumer product comprising the biodegradable perfume composition.

The details, examples and preferences provided in relation to any one or more of the stated aspects of the present invention will be further described herein and apply equally to all aspects of the present invention. Any combination of embodiments, examples and preferences described herein below in all possible variations thereof are encompassed by the present invention unless otherwise indicated herein, or otherwise clearly contradicted by context.

### DETAILED DESCRIPTION OF THE INVENTION

In the first aspect of the invention, the Group A ingredients are biodegradable perfume ingredients that are selected as the main drivers of both odour direction and olfactive performance in the perfume composition according to the invention, as more fully described herein below.

In particular embodiments of the invention, the Group A ingredients are biodegradable ingredients selected from the group consisting of biodegradable perfume ingredients selected from 3,8,8,11a-tetramethyldodecahydro-1H-3,5a-epoxynaphtho[2,1-c]oxepine (e.g. Amber-ketal); 1-(2,2,6-trimethylcyclohexyl)hexan-3-ol (e.g. Norlimbanol, Nimberol, Dextramber, Timberol); (E)-3,3-dimethyl-5-(2,2,3-trimethyl-3-cyclopenten-1-yl)-4-penten-2-ol (e.g. Polysantol); (E)-3-methyl-5-(2,2,3-trimethylcyclopent-3-en-1-yl)pent-4-en-2-ol (e.g. Ebanol); (1S,2R,5S,7R,8R)-2,6,6,8-tetramethyltricyclo[5.3.1.01,5]undecan-8-ol (e.g. Cedrol); 4-methoxy-2,2,7,7-tetramethyltricyclo[6.2.1.01,6]undec-5-ene (e.g. Symroxane); 1′,1′,5′,5′-Tetramethylhexahydro-spiro[1,3-dioxolane-2,8′(5′H)-2H-2,4a-methanonaphthalene](e.g. Ysamber K); (E)-4-methyldec-3-en-5-ol (e.g. Undecavertol); 1-phenylethyl acetate (e.g. Gardenol); (2-methoxyethyl)benzene (e.g. Pandanol); (Z)-hex-3-enyl acetate (e.g. cis-3-hexenyl acetate); (Z)-hex-3-en-1-yl butanoate (e.g. cis-3-hexenyl butyrate); 4-(4-methylpent-3-en-1-yl)cyclohex-3-enecarbaldehyde (e.g. Myraldene); (4-(4-methylpent-3-en-1-yl)cyclohex-3-en-1-yl)methyl acetate (e.g. Myraldyl acetate); dec-9-en-1-ol (e.g. Rosalva); (4E)-4,8-dimethyldeca-4,9-dienal (e.g. Floral Super); (E)-1-(2,6,6-trimethylcyclohex-2-en-1-yl)but-2-en-1-one (e.g. Damascone Alpha); (E)-1-(2,6,6-trimethylcyclohexa-1,3-dien-1-yl)but-2-en-1-one (e.g. Damascenone); 5-methyl-5-phenylhexan-3-one (e.g. Damascol); 1-methyl-4-(4-methylpentyl)cyclohex-3-enecarbaldehyde (e.g. Vernaldehyde); 1-methyl-4-(4-methylpent-3-en-1-yl)cyclohex-3-enecarbaldehyde (e.g. Precyclemone B); 7-hydroxy-3,7-dimethyloctanal (e.g. hydroxycitronellal); 3-(4-(2-methylpropyl)-2-methylphenyl)propanal (e.g. Nympheal); (E)-methyl non-2-enoate (e.g. Neofolione); 1-(5,5-dimethylcyclohex-1-en-1-yl)pent-4-en-1-one (e.g. Galbanone); 2-cyclohexylhepta-1,6-dien-3-one (e.g. Pharaone); (Z)-3-methylcyclotetradec-5-enone (e.g. Cosmone); 2-ethoxy-4-methylphenol (e.g. Ultravanil); 1-(cyclopropylmethyl)-4-methoxybenzene (e.g. Toscanol); 2,4,7-trimethyl-6-octen-1-ol (e.g. Pomelol); (2-benzyl-1,3-dioxolan-4-yl)methanol (e.g. Acetal CD); (2-(1-propoxyethoxy)ethyl)benzene (e.g. Acetal R); 3-phenylbutanal (e.g. Trifernal); (Z)-3,7,11-trimethyldodeca-6,10-dienal (e.g. Dihydro farnesal); 7-methyl-3-methylideneoct-6-enal (e.g. Verbenal); hexanal (e.g. Aldehyde C 6); (E)-hex-2-enal; 3-(4-propan-2-ylcyclohexen-1-yl)propanal (e.g. Lilybel); 4-methyl-2-(2-methylprop-1-en-1-yl)tetrahydro-2H-pyran (e.g. Rose Oxide); 1,7-dioxacycloheptadecan-8-one (e.g. Musk R1); (Z)-oxacycloheptadec-10-en-2-one (e.g. Ambrettolide); 3a,6,6,9a-tetramethyl-2,4,5,5a,7,8,9,9b-octahydro-1H-benzo[e][1]benzofuran (e.g. Cetalox); 4-(2-methoxypropan-2-yl)-1-methylcyclohexene (e.g. Flower ether); (1S,2S,4S)-2-methoxy-1,7,7-trimethylbicyclo[2.2.1]heptane (e.g. Isobornyl methyl ether); 4,7-dimethyloct-6-en-3-one (e.g. Dimethyl octenone); 6,8-dimethylnonan-2-ol (e.g. Nonadyle); (1S)-1,7,7-trimethylbicyclo[2.2.1]heptan-2-yl 2-methylpropanoate (e.g. Isobornyl isobutyrate); 2-methyl-4-oxo-4H-pyran-3-yl 2-methylpropanoate (e.g. Maltyl isobutyrate); ethyl (Z)-2-acetyl-4-methyltridec-2-enoate (e.g. Scentaurus Clean); Akigalawood, or mixtures thereof, referred to as Group A ingredients.

Group B ingredients are optional in the compositions according to the invention. A Group B ingredient is not a main driver of odour direction or odour performance and differs from Group A ingredients as such, but it can advantageously enrich the odour facets and enhance the volume and substantivity of a perfume composition according to the invention, as more fully described hereinbelow.

In particular embodiments of the invention the Group B ingredients are biodegradable ingredients selected from the group consisting of (2-benzyl-1,3-dioxolan-4-yl)methanol (e.g. Acetal CD); (2-(1-propoxyethoxy)ethyl)benzene (e.g. Acetal R); decanal (e.g. Aldehyde C 10 Decylic); 2-methyldecanal (e.g. Aldehyde C 11 MOA); undec-10-enal (e.g. Aldehyde C 11 Undecylenic); undecanal (e.g. Aldehyde C 110 Undecylic); dodecanal (e.g. Aldehyde C 12 Lauric); 2-methylundecanal (e.g. Aldehyde C 12 MNA); heptanal (e.g. Aldehyde C7 Heptylic); octanal (e.g. Aldehyde C 8 Octylic); 3,5,5-trimethylhexanal (e.g. Aldehyde C 9 Isononylic); nonanal (e.g. Aldehyde C 9 Nonylic); (E)-non-2-enal (e.g. Aldehyde C 90 Nonenylic); prop-2-enyl 2-(3-methylbutoxy)acetate (e.g. Allyl Amyl Glycolate); 3a,6,6,9a-tetramethyl-2,4,5,5a,7,8,9,9b-octahydro-1H-benzo[e][1]benzofuran (e.g. Ambrofix, Ambrox, Ambroxan); pentyl 2-hydroxybenzoate (e.g. Amyl salicylate); phenylethyl 2-methylbutanoate (e.g. Anatolyl); (2-(isopentyloxy)ethyl)benzene (e.g. Anther); (4Z)-4,11,11-trimethyl-8-methylenebicyclo(7.2.0)undec-4-ene (e.g. Caryophyllene); (1S,8aR)-1,4,4,6-tetramethyl-2,3,3a,4,5,8-hexahydro-1H-5,8a-methanoazulene (e.g. Cedrene); ((1S,8aR)-1,4,4-trimethyl-2,3,3a,4,5,8-hexahydro-1H-5,8a-methanoazulen-6-yl)methanol (e.g. Cedrenol); (Z)-hex-3-en-1-yl 2-hydroxybenzoate (e.g. cis-3-hexenyl salicylate); 3-(4-isopropylphenyl)-2-methylpropanal (e.g. Cyclamen aldehyde); cyclohexyl 2-hydroxybenzoate (e.g. Cyclohexyl salicylate); 6-pentyltetrahydro-2H-pyran-2-one (e.g. Decalactone Delta); 5-hexyloxolan-2-one (e.g. Decalactone Gamma); 3,7-dimethylocta-1,6-diene (e.g. Dihydromyrcene); 2-methyl-1-phenylpropan-2-ol (e.g. Dimethyl benzyl carbinol); 2-methyl-1-phenylpropan-2-yl acetate (e.g. Dimethyl benzyl carbinyl acetate); 2-methyl-4-phenylbutan-2-yl acetate (e.g. Dimethyl phenyl ethyl carbinyl acetate); 2-methyl-1-phenylpropan-2-ol (e.g. Dimethyl benzyl carbinol); 2-methyl-1-phenylpropan-2-yl acetate (e.g. Dimethyl benzyl carbinyl acetate); 6-heptyltetrahydro-2H-pyran-2-one (e.g. Dodecalactone Delta); 5-octyloxolan-2-one (e.g. Dodecalactone Gamma); 3-O-[1-(3,3-dimethylcyclohexyl)ethyl]1-O-ethyl propanedioate (e.g. Edenolide); 1,4-dioxacycloheptadecane-5,17-dione (e.g. Ethylene Brassylate); cyclopentadecanone (e.g. Exaltone, Musk CPD); (3E)-oxacyclohexadec-3-en-2-one (e.g. Globalide); (E)-oxacyclohexadec-12-en-2-one (e.g. Habanolide); methyl 3-oxo-2-pentylcyclopentaneacetate (e.g. Hedione); 6-ethyloxan-2-one (e.g. Heptalactone Delta); 5-propyloxolan-2-one (e.g. Heptalactone Gamma); 1-oxacycloheptadecan-2-one (e.g. Hexadecanolide); hexyl acetate (e.g. Hexyl acetate); 5-ethyloxolan-2-one (e.g. Hexalactone Gamma); hexyl 2-hydroxybenzoate (e.g. Hexyl salicylate); (E)-4-(2,6,6-trimethyl-1-cyclohex-2-enyl)but-3-en-2-one (e.g. Ionone Alpha); (E)-4-(2,6,6-trimethylcyclohex-1-en-1-yl)but-3-en-2-one (e.g. Ionone Beta); (E)-3-methyl-4-(2,6,6-trimethylcyclohex-2-en-1-yl)but-3-en-2-one (e.g. Irisantheme); (E)-4-(2,6,6-trimethylcyclohex-2-en-1-yl)but-3-en-2-one (e.g. Irisone Alpha); cyclohexadecanone (e.g. Iso-Muscone); (E)-3-methyl-4-(2,6,6-trimethylcyclohex-2-en-1-yl)but-3-en-2-one (e.g. Isoraldeine); (Z)-6-(pent-2-en-1-yl)tetrahydro-2H-pyran-2-one (e.g. Jasmin Lactone Delta); (Z)-5-(hex-3-en-1-yl)-5-methyloxolan-2-one (e.g. Jasmin Lactone Gamma); (E)-6-(pent-3-en-1-yl)tetrahydro-2H-pyran-2-one (e.g. Jasmolactone); (4Z)-hept-4-en-2-yl 2-hydroxybenzoate (e.g. Karmaflor); 3-methyl-5-phenylpentanal (e.g. Mefranal); 3-methyl-5-phenylpentan-1-ol (e.g. Mefrosol); 5-hexyl-5-methyloxolan-2-one (e.g. Methyl Decalactone Gamma); 3-methylcyclopentadecanone (e.g. Muscone); 2-(2-(4-methylcyclohex-3-en-1-yl)propyl)cyclopentan-1-one (e.g. Nectaryl); 5-pentyloxolan-2-one (e.g. Nonalactone Gamma); 6-propyltetrahydro-2H-pyran-2-one (e.g. Octalactone delta); 5-butyloxolan-2-one (e.g. Octalactone Gamma); 1,1-dimethoxycyclododecane (e.g. Palisandal); 5-heptyldihydrofuran-2(3H)-one (e.g. Peach Pure); 2-methyl-5-propan-2-ylcyclohexa-1,3-diene (e.g. Phellandrene); 2-phenylethanol (e.g. Phenyl ethyl alcohol); 2-phenylethyl acetate (e.g. Phenyl ethyl acetate); 2-phenylethyl butanoate (e.g. Phenyl Ethyl Butyrate); 2-phenylethyl 3-phenylprop-2-enoate (e.g. Phenyl Ethyl Cinnamate); 2-phenylethyl formate (e.g. Phenyl ethyl formate); 2-phenylethyl 2-methylpropanoate (e.g. Phenyl ethyl isobutyrate); 2-phenylethyl 3-methylbutanoate (e.g. Phenyl ethyl isovalerate); 3-(6,6-dimethylbicyclo[3.1.1]hept-2-en-2-yl)propanal (e.g. Pinoacetaldehyde); 4-(4-hydroxyphenyl)butan-2-one (e.g. Raspberry Ketone); (1-oxopropoxy)-acetic acid, 1-(3,3-dimethyl cyclohexyl)ethyl ester (e.g. Romandolide); 6,6-dimethylspiro[bicyclo[3.1.1]heptane-2,2′-oxirane](e.g. Rosemarel); 3-methyl-5-(2,2,3-trimethylcyclopent-3-en-1-yl)pentan-2-ol (e.g. Sandalore); oxacyclohexadecan-2-one (e.g. Thibetolide); 5-methyloxolan-2-one (e.g. Valerolactone Gamma); 2-(2-hydroxypropan-2-yl)-5-methylcyclohexanol (e.g. Geranodyle); Patchouli oil; Clove oil; Geranium oil; Orange terpenes; Eucalyptus oil; Badiane oil; Lavandin oil; Mint oil; Nutmeg oil; or mixtures thereof, referred to as Group B ingredients.

Perfume compositions of the present invention are free or substantially free of any of the following non-biodegradable ingredients, referred to as Group C ingredients:
i. Ingredients comprising a fully or partially hydrogenated methano-indene moiety, more particularly selected from (3aR,6S,7aS)-3a,4,5,6,7,7a-hexahydro-1H-4,7-methanoinden-6-yl acetate (e.g. Jasmacyclene); (3aR,6S,7aS)-3a,4,5,6,7,7a-hexahydro-1H-4,7-methanoinden-6-yl propanoate (e.g. Florocyclene); (3aR,6S,7aS)-3a,4,5,6,7,7a-hexahydro-1H-4,7-methanoinden-6-yl 2-methyl propanoate (e.g. Gardocyclene); (3aR,6S,7aS)-3a,4,5,6,7,7a-hexahydro-1H-4,7-methanoinden-6-yl 2,2-dimethylpropanoate (e.g. Pivacyclene); (3aS,4S,7R,7aS)-ethyl octahydro-1H-4,7-methanoindene-3a-carboxylate (e.g. Fruitate); (3aS,4R,6S,7R,7aR)-6-methoxy-3a,4,5,6,7,7a-hexahydro-1H-4,7-methanoindene (e.g. Verdalia); 3a,4,5,6,7,7a-hexahydro-1H-4,7-methanoinden-1-yl butyrate (e.g. Cyclobutanate); (E)-4-((3aS,7aS)-hexahydro-1H-4,7-methanoinden-5(6H)-ylidene)butanal (e.g. Dupical); 5-(allyloxy)-3a,4,5,6,7,7a-hexahydro-1H-4,7-methanoindene (e.g. Fleuroxene); (octahydro-1H-4,7-methanoinden-1-yl)methyl acetate (e.g. Mysore acetate); (3aR,4R,6S,7R,7aR)-6-methoxyoctahydro-1H-4,7-methanoindene-1-carbaldehyde (e.g. Scentenal); 1,2-dimethyl-3a,4,5,6,7,7a-hexahydro-1H-4,7-methanoinden-5-ol (e.g. Dimethyl Cyclormol); and (3aa,4a,5a,7a,7aa)-octahydro-4,7-methano-1H-inden-5-yl acetate (e.g. Dihydrocyclacet);
ii. Ingredients comprising two or more fused-ring moieties selected from 6-butan-2-yl-quinoline (e.g. 2-Isobutyl quinoline); 5-isopropylquinoline (e.g. 5-Isopropyl quinoline); decahydro-2,2,6,6,7,8,8-heptamethyl indenofuran (e.g. Amber Xtreme); 1,3,4,5,6,7-hexahydro-1,1,5,5-pentamethyl-2H-2,4a-methanona-phthalene-8-ethanol (e.g. Ambermax); (4aR,5R,7aS,9R)-octahydro-2,2,5,8,8,9a-hexamethyl-4H-4a,9-methanoazuleno[5,6-d]-1,3-dioxole (e.g. Ambrocenide); 8,8-dimethyl-1,2,3,4,5,6,7,8-octahydronaphthalene-2-carbaldehyde (e.g. Cyclo-myral); 7-isopentyl-2H-benzo[b][1,4]dioxepin-3(4H)-one (e.g. Azurone); (1R,2S,4R)-2′-isopropyl-1,7,7-trimethylspiro[bicyclo[2.2.1]heptane-2,4′-[1,3]dioxane](e.g. Belambre); 8-methyl-1,5-benzodioxepin-3-one (e.g. Calone); 1,1,2,3,3-pentamethyl-2,3,6,7-tetrahydro-1H-inden-4(5H)-one (e.g. Cashmeran); 1-(6-tert-butyl-1,1-dimethyl-2,3-dihydroinden-4-yl)ethanone (e.g. Celestolide); 1-(3,5,5,6,8,8-hexamethyl-5,6,7,8-tetrahydronaphthalen-2-yl)ethanone (e.g. Fixolide); 4,6,6,7,8,8-hexamethyl-1,3,4,6,7,8-hexahydrocyclopenta[g]isochromene (e.g. Galaxolide); 1-(1,2,8,8-tetramethyl-1,2,3,4,5,6,7,8-octahydronaphthalen-2-yl)ethanone (e.g. Georgywood); 4,4a,5,9b-tetrahydroindeno[1,2-d][1,3]dioxine (e.g. Indoflor); 1-(2,3,8,8-tetramethyl-1,2,3,4,5,6,7,8-octahydronaphthalen-2-yl)ethanone (e.g. Iso E Super, Sylvamber); 2,2,7,7-tetramethyltricyclo[6.2.1.01,6]undecan-5-one (e.g. Isolongifolanone); 2,4-dimethyl-4,4a,5,9b-tetrahydroindeno[1,2-d][1,3]dioxine (e.g. Magnolan); 1-((1S,8aS)-1,4,4,6-tetramethyl-2,3,3a,4,5,8-hexahydro-1H-5,8a-methanoazulen-7-yl)ethanone (e.g. Methyl Cedryl Ketone); 1a,3,3,4,6,6-hexamethyl-1a,2,3,4,5,6,7,7a-octahydronaphtho[2,3-b]oxirene (e.g. Moxalone); 1-(3-methylbenzofuran-2-yl)ethanone (e.g. Nerolione); 2,4-dimethyl-2-(5,5,8,8-tetramethyl-5,6,7,8-tetrahydronaphthalen-2-yl)-1,3-dioxolane (e.g. Okoumal); 2,4a,5,8a-tetramethyl-1,2,3,4,4a,7,8,8a-octahydronaphthalen-1-yl formate (e.g. Oxyoctaline Formate); (8aR)-4,4,8,8-tetramethylhexahydro-1H-3,8a-methanonaphthalen-5(6H)-one (e.g. Piconia); (4aS,8aR)-7-methyloctahydro-1,4-methanonaphthalen-6(2H)-one (e.g. Plicatone); 6-(sec-butyl)quinoline (e.g. Pyralone); (2R,8aS)-3′,6-dimethyl-3,4,4a,5,8,8a-hexahydro-1H-spiro[1,4-methanonaphthalene-2,2′-oxirane](e.g. Rhubofix); 3,7-dimethyloctan-3-ol (e.g. Terranol); and 3,6,6,7a-tetramethyloctahydro-2H-2a,7-methanoazuleno[5,6-b]oxirene (e.g. 9-Epoxycedrane);
iii. Ingredients comprising a cyclohexylidene benzoacetonitrile moiety, more particularly selected from 2-cyclohexylidene-2-phenylacetonitrile (e.g. Peonile) and 2-cyclohexylidene-2-(o-tolyl)acetonitrile (e.g. Petalia);
iv. Ingredients comprising an aromatic ring substituted by an aldehyde moiety having a secondary carbon atom in alpha position of the aldehyde group, more particularly selected from 3-(4-(tert-butyl)phenyl)-2-methylpropanal (e.g. Lilial); 2-methyl-3-[4-(2-methylpropyl)phenyl]propanal (e.g. Silvial); 3-(benzo[d]-[1,3]dioxol-5-yl)-2-methylpropanal (e.g. Tropional); benzo[d][1,3]dioxole-5-carbaldehyde (e.g. Heliotropine) and 3-(4-ethylphenyl)-2,2-dimethylpropanal (e.g. Florazolone);
v. Ingredients comprising one or more bridged cycles, selected from, bicyclo[2.2.2]oct-5-ene-2-carboxaldehyde (e.g. Maceal); 3-((1R,2S,4R,6R)-5,5,6-trimethylbicyclo[2.2.1]heptan-2-yl)cyclohexanol (e.g. Sandela); alpha-cedrene epoxide (e.g. Andrane); methyl-4(or 1)-isopropyl-1(or 4)-methylbicyclo[2.2.2]oct-5-ene-2-carboxylate (e.g. Poivrol); 1-methyl-4-(2,2,3-trimethylcyclopentyl)-2-oxabicyclo[2.2.2]octane (e.g. Cassifix); 6-ethylidenebicyclo[2.2.1]hept-2-yl propan-2-yl ether (e.g. Isoproxen); and (2S)-ethyl 3-isopropylbicyclo[2.2.1]hept-5-ene-2-carboxylate (e.g. Herbanate);
vi. Ingredients comprising a sterically hindered conjugated carbonyl moiety, more particularly selected from (E)-4-(2,5,6,6-tetramethylcyclohex-2-en-1-yl)but-3-en-2-one (e.g. Irone alpha); 1,1-diethoxy-3,7-dimethylocta-2,6-diene (e.g. Citral diethyl acetal); 1-(spiro[4.5]dec-6-en-7-yl)pent-4-en-1-one (e.g. Spirogalbanone); 4-(2,2,6-trimethyl-7-oxabicyclo[4.1.0]hept-1-yl)-3-buten-2-one (e.g. Beta ionone epoxide); (E)-1-(2,6,6-trimethylcyclohex-2-en-1-yl)hepta-1,6-dien-3-one (e.g. Cetone V); ethyl 2,6,6-trimethylcyclohexa-1,3-diene-1-carboxylate (e.g. Ethyl Safranate); 2,3,3-trimethyl-1-indanone (e.g. Safraleine); (2E)-1-(2,4,4-Trimethylcyclohex-2-en-1-yl) but-2-en-1-one (e.g. Isodamascone); 1-(2,4-dimethyl-1-cyclohex-3-enyl)-2,2-dimethylpropan-1-one (e.g. Chrisantheme); and 1-(2,6,6-trimethyl-1-cyclohex-3-enyl)but-2-en-1-one (e.g. Damascone delta);
vii. Ingredients comprising a ketal or an acetal moiety, selected from 6,6-dimethoxy-2,5,5-trimethylhex-2-ene (e.g. Methyl Pamplemousse); (1,1-diethoxypropan-2-yl)benzene (e.g. Hydratropic Aldehyde Diethyl Acetal); 2-butyl-4,4,6-trimethyl-1,3-dioxane (e.g. Herboxane); 2,4,6-trimethyl-4-phenyl-1,3-dioxane (e.g. Floropal); (ethoxymethoxy)cyclododecane (e.g. Boisambrene Forte); ethyl 2-(2-methyl-1,3-dioxolan-2-yl)acetate (e.g. Fructone); (2-(1-ethoxyethoxy)ethyl)benzene (e.g. Acetal E); (2,2-dimethoxyethyl)benzene (e.g. Viridine); 2-(cyclohexylmethyl)-4,4,6-trimethyl-1,3-dioxane (e.g. Resedal); or
viii. An ingredient selected from N-ethyl-N-(m-tolyl)propionamide (e.g. Agarbois); 1-((2-(tert-butyl)cyclohexyl)oxy)butan-2-ol (e.g. Amber Core); 3,5-diethyl-2,5-dimethylcyclohex-2-enone (e.g. Azarbre); (2-methyl-5-prop-1-en-2-ylcyclohexyl) acetate (e.g. Carhydrine); 2-benzyl-2-methylbut-3-enenitrile (e.g. Citrowanil); 2-(tert-pentyl)cyclohexyl acetate (e.g. Coniferan); ethyl 2,6,6-trimethylcyclohexa-1,3-diene-1-carboxylate (e.g. Cristalon; allyl 2-(cyclohexyloxy)acetate (e.g. Cyclogalbanate); methyl 1,4-dimethylcyclohexanecarboxylate (e.g. Cyprisate); 3-(4-ethylphenyl)-2,2-dimethylpropanenitrile (e.g. Fleuranil); 2-(tert-butyl)cyclohexyl ethyl carbonate (e.g. Floramat); ethyl 2-(2,4-dimethyl-1,3-dioxolan-2-yl)acetate (e.g. Fraistone); N,2-dimethyl-N-phenylbutanamide (e.g. Gardamide); ethyl 2-ethyl-6,6-dimethylcyclohex-2-enecarboxylate (e.g. Givescone); 2-butyl-4,6-dimethyl-3,6-dihydro-2H-pyran (e.g. Gyrane); [2-[1-(3,3-dimethylcyclohexyl)ethoxy]-2-methylpropyl]propanoate (e.g. Helvetolide); (1-ethynylcyclohexyl) acetate (e.g. Herbacet); 3,7-dimethyloctanenitrile (e.g. Hypo-Lem); (1S,2S,4S)-2-methoxy-1,7,7-trimethylbicyclo[2.2.1]heptane (e.g. Isobornyl Methyl Ether); 2,4,6-trimethylcyclohex-3-enecarbaldehyde (e.g. Isocyclocitral); 2-methyl-3-(4-methylphenyl)propanal (e.g. Jasmorange); (1-methyl-2-((1,2,2-trimethylbicyclo[3.1.0]hexan-3-yl)methyl)cyclopropyl)methanol (e.g. Javanol); 4-(1-ethoxyethenyl)-3,3,5,5-tetramethylcyclohexan-1-one (e.g. Kephalis); 2,2-dimethyl-4-phenylpentanenitrile (e.g. Khusinil); (Z)-3,4,5,6,6-pentamethylhept-3-en-2-one (e.g. Koavone); 3,4,5,6,6-pentamethylheptan-2-ol (e.g. Kohinool); (3E,6E)-2,4,4,7-tetramethylnona-6,8-dien-3-one oxime (e.g. Labienoxime); 2,2,6-trimethyl-6-vinyltetrahydro-2H-pyran (e.g. Limetol); 3-methyl-4-(2,2,6-trimethylcyclohexyl)butan-2-ol (e.g. Madranol); 2,2-dimethyl-3-(m-tolyl)propan-1-ol (e.g. Majantol); 4-[(3E)-4,8-dimethylnona-3,7-dienyl]pyridine (e.g. Maritima); 1-(3,5,6-trimethyl-1-cyclohex-3-enyl)ethanone (e.g. Methyl cyclocitrone); 2-methoxy-1,1′-biphenyl (e.g. Methyl Diphenyl Ether); 3-cyclohexyl-2,2-dimethylpropan-1-ol (e.g. Muguet alcohol); 1-(4-propan-2-ylcyclohexyl)ethanol (e.g. Muguetanol); 10-isopropyl-2,7-dimethyl-1-oxaspiro[4.5]deca-3,6-diene (e.g. Neocaspirene); 4-(tert-pentyl)cyclohexanone (e.g. Orivone); methoxycyclododecane (e.g. Palisandin); 2-ethyl-N-methyl-N-(m-tolyl)butanamide (e.g. Paradisamide); 2-methyl-4-methylene-6-phenyltetrahydro-2H-pyran (e.g. Pelargene); Ethyl-2,3,6-trimethylcyclohexyl carbonate (e.g. Rholiate); 2,4-dimethyl-4-phenyltetrahydrofuran (e.g. Rhubafuran); 2,2,2-trichloro-1-phenylethyl acetate (e.g. Rosacetol); 1-(3,3-dimethylcyclohexyl)ethyl acetate (e.g. Rosamusc); 3-(2-methylpropyl)-1-methylcyclohexanol (e.g. Rossitol); 2-(1-(3,3-dimethylcyclohexyl)ethoxy)-2-methylpropyl cyclopropanecarboxylate (e.g. Serenolide); (E)-5-methylheptan-3-one oxime (e.g. Stemone); (4E)-4-[(2Z)-But-2-en-1-ylidene]-3,5,5-trimethylcyclohex-2-en-1-one (mixture of isomers) (e.g. Tabanon); ethyl (1R,6S)-2,2,6-trimethylcyclohexane-1-carboxylate (e.g. Thesaron); 1-((2E,5Z,9Z)-2,7,8-trimethylcyclododeca-2,5,9-trien-1-yl)ethanone (e.g. Trimofix O); 4a,5-dimethyl-3-prop-1-en-2-yl-2,3,4,5,6,7-hexahydro-1H-naphthalene (e.g. Valencene); 2,2,5-trimethyl-5-pentylcyclopentanone (e.g. Veloutone); 4-methyl-4-phenylpentan-2-yl acetate (e.g. Vetikol Acetate); and (2R,5R,8S)-4,4,8-trimethyltricyclo[6.3.1.02,5]dodecan-1-yl acetate (e.g. Vetynal).

The biodegradable perfume composition may additionally comprise biodegradable additives, such as biodegradable solvents, oils, waxes, antioxidants, chelating agents, biological preservation agents, and cosmetic ingredients.

Solvents that are particularly suitable for use in the present invention are preferably biodegradable and contain a high level of renewable carbon atoms. Such solvents include dipropylene glycol, 1,2-propanediol, 1,3-propanediol, isopropylidene glycerol, triethyl citrate, diethyl citrate, and triacetin.

Preferably, the biodegradable additives are obtained from renewable or partially renewable resources.

As used herein, the term “substantially free” as it relates to Group C ingredients means that the total amount of Group C ingredients in the perfume composition of the present invention is less than 25 wt %, more particularly less than 20 wt.-%, still more particularly less than 15 wt.-%, still more particularly less than 10 wt.-%, still more particularly less than 5 wt.-%, still more particularly less than 4 wt.-%, still more particularly less than 3 wt.-%, still more particularly less than 2 wt.-%, still more particularly less than 1 wt.-%, still more particularly less than 0.5 wt.-%, still more particularly less than 0.1 wt.-%, based on the total weight of the perfume composition.

In particular embodiments of the present invention the biodegradable perfume composition consists entirely of Group A ingredients, optionally any Group B ingredients and optionally any biodegradable additive.

In particular embodiments, Group A, Group B, Group C ingredients and biodegradable additives make 100 wt.-% of the composition, provided the total amount of Group C ingredients does not exceed the limits defined hereinabove.

Such perfume compositions have the advantage of being free or substantially free of non-biodegradable Group C ingredients, while still providing both odour directions and odour impact that are typically provided by the presence of non-biodegradable Group C ingredients in the perfume composition. Moreover, Group A and Group B ingredients are not only biodegradable, but also can be prepared by methods that build-in a high level of renewable carbon.

In the context of the present invention, a “biodegradable ingredient” is an ingredient which meets the pass criteria for “inherently biodegradable” and/or “readily biodegradable” in at least one OECD biodegradation study. In order to avoid any ambiguity, this means that if an ingredient passes one test but fails one or more other ones, the pass result overrules the other test results.

For assessment of the pass criteria for “readily biodegradable”, the biodegradation study can be selected from the group consisting of OECD Method 301C, OECD Method 301D, OECD Method 301F and OECD Method 310. These methods are suitable for volatile materials.

OECD Method 301C, OECD Method 301D and OECD Method 301F are described in the OECD Guidelines for the Testing of Chemicals, Section 3, Test No. 301: “Ready Biodegradability” (Adopted: 17 Jul. 1992; https://doi.org/10.1787/9789264070349-en).

OECD Method 310 is described in the OECD Guidelines for the Testing of Chemicals, Section 3, Test No. 310: “Ready Biodegradability”—CO2 in sealed vessels (Headspace Test) (Adopted: 23 Mar. 2006; Corrected: 26 Sep. 2014; https://doi.org/10.1787/9789264016316-en).

In a particular aspect of the present invention, the pass criteria for an ingredient to be considered as readily biodegradable are assessed according to OECD Method 301F, which refers to manometric respirometry. In this method the pass level for “readily biodegradable” is to reach 60% of theoretical oxygen demand and/or chemical oxygen demand. This pass value has to be reached in a 10-day window within the 28-day period of the test. The 10-day window begins when the degree of biodegradation has reached 10% of theoretical oxygen demand and/or chemical oxygen demand and must end before day 28 of the test. A preferred way of conducting OECD Method 301F is provided herein below.

Given a positive result in a test according to OECD Method 301F, it may be assumed that the ingredient will undergo rapid and ultimate biodegradation in the environment (Introduction to the OECD Guidelines for the Testing of Chemicals, Section 3, Part 1: Principles and Strategies Related to the Testing of Degradation of Organic Chemicals; Adopted: July 2003).

For assessment of the pass criteria for “inherently biodegradable”, the biodegradation study can be OECD Method 302C, but also OECD Method 301F can be used, although with different pass criteria. Also these methods are suitable for volatile ingredients.

OECD Method 302C is described in the OECD Guidelines for the Testing of Chemicals, Section 3, Test No. 302C: Inherent Biodegradability: Modified MITI Test (II) (Adopted: 12 May 1981; Corrected 8 Sep. 2009; https://doi.org/10.1787/9789264070400-en).

In a particular aspect of the present invention, the pass criteria for “inherently biodegradable” are assessed by OECD Method 302C. In this method the pass level for “inherently biodegradable” is then to reach 70% of theoretical oxygen demand. There is no time limit to reach this level.

Biodegradation rates above 70% may be regarded as evidence of inherent, ultimate biodegradability (OECD Guidelines for the Testing of Chemicals, Section 3, Part 1: Principles and Strategies Related to the Testing of Degradation of Organic Chemicals; Adopted: July 2003).

If OECD Method 301F is used for assessment of the pass criteria for “inherently biodegradable”, the pass level is 60% of theoretical oxygen demand and/or chemical oxygen demand. This pass value can be reached after the 28-day period of the test, which is usually extended to 60 days. No 10-day window applies.

In the present context, if an ingredient is an essential oil, it is considered to be a “biodegradable ingredient” if all of its constituents present at a level Z 1 wt.-% fall under the definition of “inherently biodegradable” and/or “readily biodegradable” as defined herein above. However, the essential oil can also be subjected to the above-mentioned biodegradation tests.

It may also be advantageous that the ingredients comprised in the perfume composition according to the present invention comprise high levels of renewable carbon atoms.

In the context of the present invention, a carbon atom in a molecule is defined as “renewable”, if this carbon has been obtained or is obtainable by any of the following pathways:
I. The carbon atom belongs to a molecular moiety originating from nature, more particularly from a bio-sourced ingredient. A bio-sourced ingredient, as that term is used herein, refers to an ingredient that is extracted and/or derived from a natural source, such as plants, fungi, bacteria, algae or animal sources, preferably plants, fungi, bacteria and algae sources;
II. The carbon atom belongs to a molecular moiety that has been retrieved from CO₂);
III. The carbon atom belongs to a molecular moiety that has been retrieved from an upcycling process; or
IV. The carbon atom belongs to a molecular moiety that has been retrieved from a mixture of renewable or recycled feedstocks and fossil feedstock (so-called “mass balance carbon”);

A molecule is considered to be renewable or partially renewable if some or all of the carbon atoms present in the molecule are obtained by one or more of the pathways I. to IV.

The material from which the renewable carbon is retrieved is referred to as renewable “feedstock”.

In particular embodiments of the present invention, at least at least 50 wt.-%, more particularly at least 70 wt.-%, still more particularly at least 90 wt.-%, still more particularly at least 100 wt.-% of the carbon atoms comprised in the perfume composition are derived from renewable feedstocks.

The applicant has surprisingly found that using Group A, optionally combined with Group B ingredients, it was possible to provide a broad range of particularly desired olfactive impressions that were usually only provided by perfumes made in large part with Group C ingredients.

Furthermore, the olfactive performance, also referred to as odour strength, of the Group A ingredients and combinations thereof, including optional combinations with Group B ingredients, discovered by the applicant was similar to that of the corresponding Group C ingredient(s).

There are multiple ways to assess olfactive performance, depending on the position of the observer in the space around a perfume source and on the time after the perfume has been emitted. In the following, the immediate strength of the smell close to the source at time zero is referred to as “impact”, the duration of the smell close to the source, as “longevity”, the propagation of the smell through the space is referred to as “bloom”, and the capability of the perfume to “fill” a room, as “volume”. The impact of a perfume is its perceived intensity close to the source at the time of the application, the longevity is the perceived intensity on the substrate upon which it has been applied after a defined time following the application, the bloom is the perceived intensity at a defined distance from the source upon application, and the volume is the perceived intensity after a defined time following the application and at a defined distance from the point of application. Furthermore, if the source (or the observer) is moving, the perceived intensity at some distance of this source is called “trail” (or “sillage”).

In the context of the present invention, the olfactive performance of an ingredient, a combination of ingredients or of a finished perfume composition is assessed at all of the assessment points that are relevant for a given application. These assessment points may include, for instance, the odour strength measured on opening a bottle comprising the perfumed product, during the use of this product, on opening a wash machine, on wet substrate, on dry substrate, and close to or distant from the source of perfume. Group A perfume ingredients may be considered as the main drivers of both odour directions and olfactive performance in the perfume composition according to the invention, whereas Group B perfume ingredients may advantageously enrich the odour facets and enhance the volume and substantivity of the compositions.

The perfume composition may comprise perfume ingredients that are different from Group A, Group B and Group C ingredients, provided these ingredients are biodegradable. Such perfume ingredients include biodegradable ingredients having at least 50 wt.-%, more particularly at least 70 wt.-%, still more particularly at least 90 wt.-%, still more particularly at least 100 wt.-% renewable carbon atoms. Such ingredients may be selected from the group consisting of essential oils, such as lemon oils, almond oils, cedarwood oils, citrus oils, jasmine oils, mandarin oils, neroli oils, rose oils and tonka oils; terpenes, such as limonene, alpha and beta pinene, and myrcene; terpene alcohols and their derivatives, such as geraniol, citronellol, linalool, tetrahydrolinalool, nerol, myrcenol, and dihydromyrcenol; terpene alcohol esters, such as linalyl acetate, citronellyl acetate, and geranyl isobutyrate. In particular embodiments of the present invention, the perfume composition comprises from 8 wt.-% to 40 wt.-%, more particularly from 9 wt.-% to 30 wt.-% of Group A ingredients and from 0 wt.-% to 92 wt.-%, more particularly from 4 wt.-% to 60 wt.-% of Group B ingredients, based on the total weight of perfume ingredients in the composition.

If present, biodegradable additives referred to hereinabove are not considered as perfume ingredients and are not taken into account in the calculation of the weight percentages of Group A and Group B perfume ingredients.

Perfume compositions according to the invention agreeing with the principles of perfume design in accordance with the invention are disclosed below, wherein each of the following embodiments describe how particular odour contributions can be created.

In particular embodiments of the present invention, a fruity, clean, blooming and substantive odour contribution typically provided by the so-called “cyclene” family of perfume ingredients, characterized by the non-biodegradable, non-renewable hydrogenated methano-indene moiety, may be successfully reproduced by combining at least two ingredients selected from (E)-4-methyldec-3-en-5-ol (Undecavertol) at a level of from 5 wt.-% to 25 wt.-% with 1-(cyclopropylmethyl)-4-methoxybenzene (Toscanol) at a level of from 0.2 wt.-% to 0.5 wt.-%, (E)-4-(2,6,6-trimethylcyclohex-1-en-1-yl)but-3-en-2-one (Ionone-beta) at a level of from 2 wt.-% to 20 wt.-%, 2-(2-(4-methylcyclohex-3-en-1-yl)propyl)cyclopentan-1-one (Nectaryl) at a level of from 2 to 40 wt.-%, hexyl acetate at a level of from 0.5 wt.-% to 5 wt.-%, pentyl 2-hydroxybenzoate (Amyl salicylate) at a level of from 5 wt.-% to 15 wt.-% and (Z)-hex-3-en-1-yl 2-hydroxybenzoate (Cis-3-hexenyl salicylate) at a level of from 5 wt.-% to 15 wt.-%, based on the total weight of perfume ingredients in the composition.

The use of a mixture of perfume ingredients referred to in the paragraph immediately above, with all percentages expressed in parts of said mixture, as a replacement for so-called “cyclene” family ingredients, as well as perfume compositions containing said mixture and absent “cyclene” family ingredients, represent particular embodiments of the invention. Such a mixture can be referred to as a “Cyclene replacer” in the present disclosure.

The green and powerful odour contribution provided by quinolines, such as from 6-butan-2-yl-quinoline; 5-isopropylquinoline and 6-(sec-butyl)quinoline, may be successfully reproduced by combining at least two selected from 1-phenylethyl acetate (Gardenol) at a level of from 5 wt.-% to 15 wt.-%, (2-methoxyethyl)benzene (Pandanol) at a level of from 0.3 wt.-% to 5 wt.-%, hexanal (Aldehyde C 6) at a level of from 0.5 wt.-% to 2 wt.-%, 3-phenylbutanal (Trifernal) at a level of from 0.3 wt.-% to 2 wt.-%, (E)-hex-2-enal at a level of from 0.1 wt.-% to 1 wt.-%, (Z)-hex-3-en-1-ol (cis-3-hexenol) at a level of from 1 wt.-% to 2 wt.-%, (Z)-hex-3-en-1-yl acetate (cis-3-hexenyl acetate) at a level of from 0.3 wt.-% to 2 wt.-%, prop-2-enyl 2-(3-methylbutoxy)acetate (Allyl amyl glycolate) at a level of from 1 wt.-% to 5 wt.-%, 1-(5,5-dimethylcyclohex-1-en-1-yl)pent-4-en-1-one (Galbanone) at a level of from 0.2 wt.-% to 1 wt.-%, (E)-methyl non-2-enoate (Neofolione) at a level of from 1 wt.-% to 10 wt.-% and 2-cyclohexylhepta-1,6-dien-3-one (Pharaone) at a level of 0.1 wt.-% to 0.3 wt.-%, based on the total weight of perfume ingredients in the composition.

The use of a mixture of perfume ingredients referred to in the paragraph immediately above, with all percentages expressed in parts of said mixture, as a replacement for quinolines, as well as perfume compositions containing said mixtures and absent quinolines, represent particular embodiments of the invention. Such mixtures can be referred to as a “quinoline replacer” in the present disclosure.

The woody-amber, clean, blooming and substantive odour contribution provided by the non-biodegradable 1-(2,3,8,8-tetramethyl-1,2,3,4,5,6,7,8-octahydronaphthalen-2-yl)ethanone (Iso E Super) may be successfully reproduced by combining at least two ingredients selected from 1-(2,2,6-trimethylcyclohexyl)hexan-3-ol (Norlimbanol) at a level of from 2 wt.-% to 4 wt.-%, (E)-3,3-dimethyl-5-(2,2,3-trimethyl-3-cyclopenten-1-yl)-4-penten-2-ol (Polysantol) at a level of from 2 wt.-% to 4 wt.-%, (1S,2R,5S,7R,8R)-2,6,6,8-tetramethyltricyclo[5.3.1.01,5]undecan-8-ol (Cedrol) at a level of from 10 to 25 wt.-%, 3a,6,6,9a-tetramethyl-2,4,5,5a,7,8,9,9b-octahydro-1H-benzo[e][1]benzofuran (Ambrofix) at a level of from 1 wt.-% to 5 wt.-%, Akigalawood at a level of 0.2 to 2 wt.-%, 1-methyl-4-(4-methylpent-3-en-1-yl)cyclohex-3-enecarbaldehyde (Precyclemone) at a level of from 1 wt.-% to 10 wt.-%, and (E)-3-methyl-5-(2,2,3-trimethylcyclopent-3-en-1-yl)pent-4-en-2-ol (Ebanol) at a level of from 1 wt.-% to 5 wt.-%, based on the total weight of perfume ingredients in the composition.

The use of a mixture of perfume ingredients referred to in the paragraph immediately above, with all percentages expressed in parts of said mixture, as a replacement for Iso E Super, as well as perfume compositions containing said mixtures and absent Iso E Super, represent particular embodiments of the invention. Such mixtures can be referred to as an “Iso E replacer” in the present disclosure.

New powerful neroli contributions may be obtained by using 4-(2-methoxypropan-2-yl)-1-methylcyclohexene (Orange flower ether) at a level of from 0.3 to 2 wt.-%, based on the total weight of perfume ingredients in the composition.

The use of a mixture of perfume ingredients referred to in the paragraph immediately above, with all percentages expressed in parts of said mixture, as a replacement for non-biodegradable neroli ingredients, as well as perfume compositions containing said mixtures and absent non-biodegradable neroli ingredients, represent particular embodiments of the invention. Such mixtures can be referred to as a “Neroli replacer” in the present disclosure.

New powerful floral contributions may be obtained by combining at least two, preferably at least three ingredients selected from 4-(4-methylpent-3-en-1-yl)cyclohex-3-enecarbaldehyde (Myraldene) at a level of from 5 wt.-% to 15 wt.-%, (4-(4-methylpent-3-en-1-yl)cyclohex-3-en-1-yl)methyl acetate (Myraldyl acetate) at a level of from 1 wt.-% to 10 wt.-%, dec-9-en-1-ol (Rosalva) at a level of from 0.2 wt.-% to 2 wt.-%, 1-methyl-4-(4-methylpentyl)cyclohex-3-enecarbaldehyde (Vernaldehyde) at a level of from 1 wt.-% to 10 wt.-%, 1-methyl-4-(4-methylpent-3-en-1-yl)cyclohex-3-enecarbaldehyde (Precylemone) at a level of from 1 wt.-% to 10 wt.-%, 7-hydroxy-3,7-dimethyloctanal (Hydroxycitronellal) (Hydroxycitronellal) at a level of from 1 to 10 wt.-%3-(4-(2-methylpropyl)-2-methylphenyl)propanal (Nympheal) at a level of from 1 wt.-% to 15 wt.-%, 4-methyl-2-(2-methylprop-1-en-1-yl)tetrahydro-2H-pyran (Rose oxide) at a level of from 0.1 wt.-% to 5 wt.-% and (E)-4-methyldec-3-en-5-ol (Undecavertol) at a level of 10 wt.-% to 25 wt.-%, based on the total weight of perfume ingredients in the composition.

The use of a mixture of perfume ingredients referred to in the paragraph immediately above, with all percentages expressed in parts of said mixture, as a replacement for non-biodegradable floral ingredients, as well as perfume compositions containing said mixtures and absent non-biodegradable floral ingredients, represent particular embodiments of the invention. Such mixtures can be referred to as a “Floral replacer” in the present disclosure.

New powerful berry contributions may be obtained by combining (E)-3-methyl-4-(2,6,6-trimethylcyclohex-2-en-1-yl)but-3-en-2-one (Isoraldeine) at a level of from 10 wt.-% to 50 wt.-%, (E)-4-(2,6,6-trimethylcyclohex-2-en-1-yl)but-3-en-2-one (Irisone alpha) et a level of from 10 wt.-% to 50 wt.-%, (E)-1-(2,6,6-trimethylcyclohex-2-en-1-yl)but-2-en-1-one (Damascone alpha) at a level of from 0.1 wt.-% to 1 et.-%, 4-(4-hydroxyphenyl)butan-2-one (Raspberry ketone) at a level of from 5 wt.-% to 25 wt.-%, and 2-methyl-4-oxo-4H-pyran-3-yl 2-methylpropanoate (Maltyl isobutyrate) et a level of from 0.1 wt.-% to 1 wt.-%, based on the total weight of perfume ingredients in the composition.

The use of a mixture of perfume ingredients referred to in the paragraph immediately above, with all percentages expressed in parts of said mixture, as a replacement for Damascone Delta, as well as perfume compositions containing said mixtures and absent Damascone Delta, represent particular embodiments of the invention. Such mixtures can be referred to as a “Damascone Delta replacer” in the present disclosure.

New powerful grapefruit contributions may be obtained by using 2,4,7-trimethyl-6-octen-1-ol (Pomelol) at a level of 5 to 25 wt.-%, based on the total weight of perfume ingredients in the composition.

The use of Pomelol as a replacement for grapefruit ingredients, as well as perfume compositions containing said mixtures and absent non-biodegradable grapefruit ingredients, represent particular embodiments of the invention. Such mixtures can be referred to as a “Grapefruit replacer” in the present disclosure.

Further powerful contribution may be obtained by using one or more ingredients selected from 2-ethoxy-4-methylphenol (Ultravanil) at a level of from 0.1 wt.-% to 1 wt.-%, (1S,2S,4S)-2-methoxy-1,7,7-trimethylbicyclo[2.2.1]heptane (Isobornyl methyl ether) at a level of from 0.5 wt.-% to 5 wt.-%, Pinoacetaldehyde at a level of from 1 wt.-% to 20 wt.-% and 1-(cyclopropylmethyl)-4-methoxybenzene (Toscanol) at a level of from 0.1 wt.-% to 0.5 wt.-%, based on the total weight of perfume ingredients in the composition.

The use of 2-ethoxy-4-methylphenol (Ultravanil), (1S,2S,4S)-2-methoxy-1,7,7-trimethylbicyclo[2.2.1]heptane (Isobornyl methyl ether), 1-(cyclopropylmethyl)-4-methoxybenzene (Toscanol), or mixtures thereof to enhance the performance of perfume compositions represent additional embodiments of the invention.

The replacers referred to herein are especially useful in applications requiring odour blooming and longevity on dry substrates, such as laundry care, hair care, skin care and hard surface care. More particularly, in laundry care, these replacers provide odour blooming on opening wash machines and on wet fabrics, as well as longevity on dry fabrics, for example after 24 hours line drying.

Perfume compositions according to the invention are typically composed of more than one odour contribution. For instance a perfume composition may be composed of fruity, green and woody-amber odour contributions.

Accordingly, in a particular embodiments of the present invention, the perfume composition comprises at least 3, more particularly at least 4, still more particularly at least 5, still more particularly at least 6, still more particularly at least 7 ingredients selected from Group A ingredients, and, if present at least 3, more particularly at least 4, still more particularly at least 5 ingredients, still more particularly at least 6 ingredients, still more particularly at least 7 ingredients selected from Group B ingredients.

In the second aspect, the present invention provides a method for obtaining a biodegradable perfume composition comprising the steps of mixing:
a) From 8 wt.-% to 40 wt.-%, more particularly from 9 wt.-% to 30 wt.-% of Group A ingredients;
b) From 0 wt.-% to 92 wt.-%, more particularly from 4 wt.-% to 60 wt.-% of Group B ingredients; and
c) From 0 wt.-% to 92 wt.-% of one or more ingredients that are different from Group A and Group B ingredients to complete to 100 wt.-%, wherein the one or more optional ingredients that are different from Group A and Group B ingredients are biodegradable and free or substantially free of Group C ingredients, wherein the term “substantially free” is as defined above.

In regard to c), the one or more ingredients that are different from Group A and Group B ingredients may include one or more biodegradable additives, as defined hereinabove.

In such a method, all of the preferences and embodiments described above in relation to the first aspect of the invention apply equally to the second aspect and are not repeated here for brevity.

The perfume composition according to the invention may also be encapsulated in various formats, such as spray dry carbohydrate encapsulates or core-shell microcapsules formed by coacervation, condensation polymerization, interfacial polymerization or any other methods known in the art for the production of perfume encapsulates.

Similarly, each of the replacers disclosed hereinabove may be encapsulated as such or mixed with other ingredients, including perfume ingredients, referred to herein and used to obtain a perfume composition that may then be encapsulated.

In particular embodiments, a perfume composition is encapsulated in a biodegradable matrix or a core-shell microcapsule having a biodegradable or partially biodegradable shell. Biodegradable or partially biodegradable shells may be obtained by cross-linking carbohydrates, modified carbohydrates, proteins, modified and/or denaturised proteins by using methods known to the art.

In particular embodiments, core-shell microcapsules having a biodegradable or partially biodegradable shell may be obtained as described in WO 2020/233887 A1, more particularly as described in Examples 1, 2, 4, 5 and 6 of that document. In other particular embodiments, core-shell microcapsules having a biodegradable or partially biodegradable shell may be obtained by as described in WO 2021/239742 A1, more particularly as described in Examples 1.3 to 1.6 of that document.

In other particular embodiments, core-shell microcapsules having a biodegradable or partially biodegradable shell may be obtained by method comprising the steps of:
a) Providing an aqueous phase;
b) Providing an oil phase comprising a perfume composition;
c) Emulsifying the oil phase in the aqueous phase to form an emulsion of oil droplets in the aqueous phase;
d) Forming a polymeric stabilizer surrounding the oil droplets formed by reaction of an aminosilane with a polyfunctional isocyanate;
e) Providing a biodegradable hydrated polymer phase on an outer face of the polymeric stabilizer, in order to obtain a microcapsule shell.

In the third aspect of the invention Group A and optionally Group B ingredients are used as replacers of non-biodegradable ingredients, such as Group C ingredients, to enhance the olfactive performance of biodegradable perfume compositions.

In particular embodiments, at least 3, more particularly at least 4, still more particularly at least 5, still more particularly at least 6, still more particularly at least 7 ingredients selected from Group A ingredients, and, if present at least 3, more particularly at least 4, still more particularly at least 5 ingredients selected from Group B ingredients can be used to enhance the olfactive performance of biodegradable perfume compositions according to the invention.

In using the Group A and optionally Group B ingredients in accordance with the third aspect of the invention, all of the preferences and embodiments described above with regard to the first aspect of the invention apply equally to the third aspect of the invention.

The fourth aspect of the invention is concerned with consumer products comprising the perfume compositions of the present invention.

The consumer products that may be concerned by the present invention include laundry care products, such as powder and liquid detergents, liquid softeners, softening sheets, and scent boosters; personal care products, such as shampoos, skin and hair conditioners, shower gels, liquid and bar soaps, and cleansing compositions; and home care products, such as hard surface cleaners, dish washing liquids, surface enhancers, toilet blocks, and air care products.

In many cases, and especially in the laundry care, personal care and home care categories, the consumer products concerned by the present invention contain one or more surfactant, selected from anionic, cationic, cationogene and amphoteric or non-ionic surfactants.

In particular embodiments the consumer product is a laundry care product, still more particularly a laundry detergent, comprising the perfume composition according to the present invention.

In particular embodiments, the laundry detergent comprises at least one bio-sourced surfactant selected from alkyl amino acid esters, amino acid amides, polyglycerides, polyglyceryl fatty acid, alkyl polygucosides and alkyl polyglucoside esters, alkyl polypentosides, sugar amides, more particularly oleyl glucamide, and glycolipids, more particularly rhamnolipids, and sophorolipids.

Alkyl polygucosides and alkyl polypentosides typically comprise linear alkyl chains having from 8 to 14 carbon atoms and 1 to 6, more particularly, in average, 1 to 2 sugar moieties. Alkyl polyglucoside esters are obtained by esterification of alkyl polyglucosides with water-soluble acids, such as sulfosuccinic acid, tartaric acid or citric acid.

Rhamnolipids are obtained by fermentation and consist of a rhamnose molecule linked to a 3-(hydroxyalkanoyloxy)alkanoic fatty acid, such as 3-hydroxydecanoic acid.

Sophorolipids are obtained by fermentation and consist of a sophorose molecule (2-O-β-d-glucopyranosyl-d-glucopyranose) linked to a terminal or sub-terminal hydroxylated fatty acid, such as oleic acid and ricinoleic acid.

In particularly preferred embodiments, the bio-sourced surfactant is a rhamnolipid.

Rhamnolipids have the advantage of offering a better rendition of the olfactive character of perfume compositions according to the invention.

In particular embodiments of the invention, the consumer product may additionally comprise one or more enzymes selected from the group comprising lipases, protease and cellulases.

In particular embodiments, the consumer product may comprise from 0.1 to 5 wt.-%, more particularly from 0.25 to 2.5 wt.-%, still more particularly from 0.5 to 2 wt.-% of perfume composition according to the present invention.

In such consumer products, all of the embodiments and preferences described above with regard to the first aspect of the invention apply equally to this fourth aspect of the invention.

The perfume compositions of the present invention are biodegradable. Biodegradation is of particular importance because both during and after their intended use, the compositions or parts thereof may enter the environment via domestic waste water. Biodegradation is the main process of removal in waste water treatment plants, environmental waters and soils.

The perfume ingredients useful in the present invention to create biodegradable perfume compositions are themselves biodegradable.

Biodegradability can be measured according to known OECD methods. The following is a preferred way for conducting OECD Method 301F.

### Principle

A measured volume of inoculated mineral medium, containing a known concentration of test substance as the nominal sole source of organic carbon, is stirred in a closed flask at a constant temperature. Evolved carbon dioxide is absorbed in sodium hydroxide pellets. The consumption of oxygen is determined by measuring the pressure drop in the respirometer flask. The Biological Oxygen Demand (BOD), amount of oxygen taken up by the microbial population during biodegradation of the test chemical (corrected for uptake by blank inoculum, run in parallel) is expressed as a percentage of ThOD (Theoretical Oxygen Demand, calculated from the elemental composition, assuming that carbon is oxidized to carbon dioxide, hydrogen to water and nitrogen to ammonium, nitrite or nitrate).

### Apparatus:

The respirometer used is an Oxitop Control System, made by Wissenschaftlich-Technische Werkstätten (WTW), Weilheim, Germany.

### Water:

The water used is ultrapure water, containing less than 5 ppb total organic carbon, produced by using a Millipore Direct-Q 3 UV purification system.

### Stock Solutions of Mineral Components:

### Solution A:

| | | |
|---|---|---|
| KH2PO4 | 8.5 | g |
| K2HPO4 | 21.75 | g |
| Na2HPO4•2 H2O | 33.4 | g |
| NH4Cl | 0.5 | g |

dissolved in water and made up to 1 liter.

### Solution B:

| | |
|---|---|
| CaCl2 | 27.5 g |

dissolved in water and made up to 1 liter.

### Solution C:

| | |
|---|---|
| MgSO4•7 H2O | 22.5 g |

dissolved in water and made up to 1 liter.

### Solution D:

| | |
|---|---|
| FeCl3•6 H2O | 0.25 g |
| HCl Conc. | one drop |

dissolved in water and made up to 1 liter.

### Mineral Medium:

The mineral medium is prepared by mixing 50 ml of solution A and 2 liters deionized water, adding 5 ml of each of the solutions B, C and D and making up to 5 liters with deionized water. The pH is measured and if necessary adjusted to 7.4±0.2 with phosphoric acid or potassium hydroxide.

### Inoculum:

Fresh activated sludge from a biological waste water treatment plant treating predominantly domestic sewage (Bois-de-Bay, Satigny, Switzerland) is used.

The sludge is collected in the morning, washed three times in the mineral medium (by centrifuging at 1000 g for 10 minutes, discarding the supernatant and re-suspending in mineral medium) and kept aerobic until being used on the same day.

### Reference Substance:

Sodium benzoate (Fluka, Buchs, Switzerland, Art. No. 71300), purity: min. 99.0%.

### Preparation of the Flasks:

Test substance samples (corresponding to 30.0 mg/I in 255 ml of test medium) are weighed in small aluminium boats and added directly to the test flasks of the Oxitop. For reference substance samples 12.75 mg (corresponding to 50.0 mg/I in 255 ml of test medium) are weighed in small aluminium boats and added directly to the test flasks of the Oxitop.

Flasks are filled with 250 ml of mineral medium. Samples of test or reference substance are added. Then 5.00 ml of suspended sludge diluted to a concentration of 1.53 g/I dry matter is added. Except when the test substance had an acid or alkaline character, the pH of each flask is not measured but assumed to be the same as the mineral medium, in order not to remove any floating undissolved test substance from the test medium by dipping a glass electrode in it. Neutral test substances, even sodium benzoate, were shown not to affect the pH of the medium by more than 0.1 pH unit. Two sodium hydroxide pellets are placed in the quivers on top of the bottle, and the flasks are closed tightly with the measuring heads. The flasks are allowed to equilibrate to the test temperature. The measurement is started by programming the measuring unit of the Oxitop test flasks, and the test flasks are placed in the temperature controlled cupboard of the Oxitop system. After temperature equilibration, the controller of the instrument started data acquisition (time zero of the experiment).

### Test Temperature:

The test temperature is 21.5±0.5° C.

### Performance of the Test:

Every day the oxygen consumption of each flask is recorded, and correct temperature and stirring are checked. At the end of the test period (normally 28 days), the pH of each flask is measured again.

The biodegradation for each data point is calculated as follows:

$$D = ( C - B ) / ThOD \cdot 100 \%$$

D: Biodegradation of sample
C: O2 uptake of sample and sludge
B: O2 uptake of sludge (inoculum blank)
ThOD: Theoretical oxygen demand

The pass level for an ingredient to be considered as “readily biodegradable” is to reach 60% of theoretical oxygen demand (ThOD). This pass value has to be reached in a 10-day window within the 28-day period of the test. The 10-day window begins when the degree of biodegradation has reached 10% of theoretical oxygen demand (ThOD) and must end before day 28 of the test.

The pass level for “inherently biodegradable” is also 60% of theoretical oxygen demand (ThOD). However, this pass value can be reached after the 28-day period of the test, which is usually extended to 60 days. No 10-day window applies.

Further features and particular advantages of the present invention become apparent from the following examples.

### Example 1—Perfume Formulas

A series of perfumes were created and their compositions are shown in Table 1. Sample BM is a conventional laundry detergent perfume comprising 38.5% of non-biodegradable ingredients (NBD) and was taken as benchmark.

TABLE 1
Perfume compositions

| | Group | BM | A | B | D | E | F | G | H | I | J | K | L | M |
|---|---|---|---|---|---|---|---|---|---|---|---|---|---|---|
| Agrumex | NBD | 13.5 | | | | | | | | | | | | |
| Florocyclene | NBD | 9 | | | | | | | | | | | | |
| Jasmacyclene | NBD | 8 | | | | | | | | | | | | |
| Radjanol Super | NBD | 2.5 | | | | | | | | | | | | |
| Iso E Super | NBD | 2.5 | | | | | | | | | | | | |
| Yara Yara | NBD | 1 | | | | | | | | | | | | |
| Rosacetol | NBD | 1 | | | | | | | | | | | | |
| Lemonile | NBD | 1 | | | | | | | | | | | | |
| Benzyl Acetate | | | | 1 | | | | | | | | | 2 | |
| Cis-3-Hexenyl Acetate | A | | | | | 0.4 | | | | | | | | |
| Hexyl Acetate | B | | 4 | | 0.5 | 0.5 | 4 | | 0.5 | | | | 0.5 | 12 |
| Linalyl Acetate | | | 1.2 | | | | 1.2 | | | | | | | 6 |
| Myraldyl Acetate | A | | | | | | | | 4 | | | | | |
| Neryl Acetate | | | 4 | | 0.75 | 4 | 10 | 5 | 4 | | | | | 6 |
| Nopyl Acetate | | 4 | 3 | 0.8 | | | | | 7 | | | | | |
| Phenyl Ethyl Alcohol | | 5.5 | 0.3 | | | | | | | | | | | |
| Phenyl Ethyl Acetate | | | 1.2 | | | | | | 0.7 | | | | | |
| Terpenyl Acetate | | | | 30.5 | 19.8 | | | 18 | 22 | 5 | | | | |
| Hexyl Cinnamic Aldehyde | | | | | | 8 | | 4.5 | | | 10 | | 30 | |
| Decanal | B | 0.5 | | | | | | | | | | 1.5 | | |
| Undec-10-enal | B | | | | | | | 0.8 | 2 | | | | | 1 |
| Undecanal | B | | 2.4 | | | | | | | | | | | |
| Aldehyde C 12 Lauric | B | | | | 2.25 | 2 | | | 1.8 | | | 1.5 | | |
| Aldehyde C 12 MNA | B | 1 | | | | | | | | 8.5 | | | | |
| Nonanal | B | | 0.8 | | 0.1 | | | | | | | | | |
| Cyclamen Aldehyde | B | | | | 0.8 | | | | | | | | | |
| Aldehyde Iso C 11 | A | | | 0.8 | 0.08 | | | 0.4 | 0.7 | | | 4.5 | | |
| Akigalawood | A | | | | | | | | | | | 0.1 | | |
| Amberketal | A | | | | | | | 0.4 | | | 0.5 | | | |
| Ambrettolide | A | | 0.2 | 0.1 | 0.4 | | 4 | 3.7 | 0.4 | | | 5 | | 6 |
| Ambrofix | A | | 1.2 | 1.2 | 0.04 | 1.2 | 0.4 | 1.4 | 0.1 | 0.4 | 1.5 | 4 | | 2 |
| Anethol | | | | | 0.1 | 0.5 | 2.7 | 0.6 | 0.15 | | | | | |
| Benzyl Acetone | | 7 | | | 0.8 | | | | | | | | | |
| Allyl Hexanoate | | | | | 0.7 | 0.5 | 1 | | | | | | | |
| Carvone Laevo | | | | | | | | 3 | | | | | | |
| Caryophyllene | B | | 3 | | | | | | | | | | | 2 |
| Cedrat Oil | | | | | | | | | | | 3 | | | |
| Cedrene | B | | | | | | | | | | | 1 | | 1.8 |
| Citronellol | | | 3 | | | | | | | | | | | 5 |
| Citronellyl Acetate | | | | | | | | | | | | 9 | 5 | 11 |
| Citronellyl Nitrile | | | | | | | | | 0.2 | | | 7.5 | | |
| Citronnelle Oil | | | 0.2 | | | | | | 1 | | | 1.5 | | |
| Cosmone | A | | 0.3 | | | | | | | | | | 0.3 | |
| Damascone Alpha | A | | 0.2 | 0.1 | 0.7 | | 0.15 | | 0.1 | | | | | |
| Dihydro Farnesal | A | | 0.5 | | | | 0.1 | | | | | | | |
| Dihydro Myrcenol | | 31 | 30 | 32 | 17.5 | | 10.9 | 12 | 3 | 26 | 3 | 12.5 | | |
| Ebanol | A | | 0.5 | | | 5 | 4 | | 2 | 3.5 | | | 5 | |
| Elemi Oil | | | | | | | | | | | | 1.5 | | |
| Ethyl Cinnamate | | | | | | | | | | 4.5 | | | | |
| Ethyl Hexanoate | | | | 0.25 | 0.5 | 1 | 2 | | 1 | | | | 1.5 | |
| Ethyl Linalol | | | | 1.5 | | | | | | | | | | |
| Eucalyptol | | | | 0.8 | | | | | 0.3 | | | 2.5 | | |
| Eugenol | | 0.5 | | 0.8 | | | | | 4 | 4.4 | | | | 5 |
| Galbanone Pure | A | | 0.2 | 0.4 | 0.25 | | | | | 0.4 | | | | |
| Gardenol | A | 3 | | | | 0.7 | | | 0.5 | | 0.5 | 10.8 | | |
| Geraniol | | | 2.5 | | | | | | | | | | | 5 |
| Geranium Oil | B | | 0.5 | | | | | | 0.5 | | | | | |
| Geranodyle | | | | | | | | | 1 | | 4 | | 5 | |
| Gingembre Oil | | | | | | | | | | | | 7.55 | | |
| Girofle Oil | B | | | | | | | | | | | 1.5 | | |
| Habanolide | B | 1 | | 4 | | | | | | | | | 5 | |
| Hedione | | 1.5 | 0.1 | 0.5 | 0.15 | | | | | | | | | 3 |
| Trans-2-Hexenal | A | | | | 0.15 | | 0.2 | | | | | | | |
| Cis-3-Hexenol | A | | | | | | 1 | | | | | 1.5 | | |
| Hydroxycitronellal | A | | 4 | | | | | | | | | | | |
| Ionone Beta | B | | 0.5 | 8.2 | 1.1 | | 3 | 1 | | 6 | 12 | 1 | | 12 |
| Irisone Alpha | B | | 0.8 | 0.35 | | 1.8 | | | | | | | | |
| Maltyl Isobutyrate | A | | | | | 4 | 0.1 | | 0.05 | | | | | |
| Isoeugenol | | | | 0.1 | 0.1 | | | 0.1 | 0.05 | | | 0.1 | | |
| Isoraldeine 70 | B | | 4 | 1 | | 46.9 | | | 4 | | | | | |
| Lavandin Oil | | | 1.1 | | | | | | 1.2 | | | | | 1 |
| Limette Oil | | | | | | | | | | | | 4 | | |
| Linalool | | | 6 | | | 6 | 6 | | | | | | | 10 |
| Mandarine Oil | | | 1.5 | | | | | | | | | | | |
| Ethyl 2-Methylbutyrate | | | 1 | | 1.5 | 0.08 | 0.5 | | 0.05 | | | | | |
| Moss Extract | | | | | | | | 1.5 | | | | | | |
| Musk R1 | A | | | | | 0.7 | 4 | | 0.5 | | | | | |
| Myraldene | A | | | | 6.5 | | | | | 6 | | | | 2 |
| Nectaryl | B | | | 4 | 18.1 | 4 | 25 | 2 | | 8 | | | | 3 |
| Neofolione | A | 1 | 3 | | 0.2 | 6 | 3 | 0.8 | | | | | | |
| Nerol | | | | | | | | | | | | | 5 | |
| Neryl Acetate | | | | | | | | | | 5 | | | | |
| Nimberol | A | | | 4 | | | | | | | | | | |
| Nonalactone Gamma | B | | | | | | | | | 1.5 | | | | |
| Nympheal | A | | | | 2 | | | | | | | | | |
| Octalactone Gamma | B | | | | | 0.5 | | | | | | | | |
| Orange Aldehyde | | | 5 | | | | | | | | | | | |
| Orange Oil | | | | 3 | | | 4 | | | | | | | |
| Orange Flower Ether | A | | | | | | | 15 | 1.5 | 0.5 | | | | |
| Orange Terpenes | | | | | 5.2 | | | 6 | 3 | 10 | | 12.5 | | |
| Palmarosa Ess | | | 0.5 | | | | | | | | | | | 1 |
| Pandanol | A | | | 0.1 | | | | | | 0.5 | | | | |
| Patchouli Oil | B | 0.5 | 0.5 | | | 0.3 | | 0.3 | | 1 | 0.15 | 4 | | |
| Peach Pure | B | 1 | | | | 4 | 10 | | 0.5 | | | | 15 | |
| Pelargol | | | | | | | | | 4 | | | | | |
| Pinene Alpha | | | | | | | | | | | | 2 | | |
| Pinoacetaldehyde | | | 1 | 0.5 | | 0.5 | 1 | 15 | | | 0.3 | | | |
| Polysantol | A | | | 4 | | | | | | | | | | |
| Pomelol | A | | | | | | | | | | 10 | | | |
| Precyclemone B | A | | | | 6.5 | | 1 | 4 | | | | | 5 | |
| Raspberry Ketone | B | | 0.1 | | | | | | | | 7 | | | |
| Rosalva | A | | 1 | | | 0.8 | 0.2 | | 1 | | | 1 | | 1.2 |
| Rose Oxide | A | | 1.5 | | | | | | | 0.3 | 1.05 | 2 | | 4 |
| Sandalore Extra | B | | | | | | | | | | 47 | | | |
| Cis-3-Hexenyl Salicylate | B | 1.5 | | | | | | | | | | | 10.2 | |
| Super Muguet | | | | | 0.75 | | | | | | | | | |
| Terpineol | | | 8 | | 1.5 | | | 3.5 | 3 | 8.5 | | | | |
| Tetrahydro Linalool | | 2.5 | | | | | | | 23.7 | | | | | |
| Toscanol | A | | 0.3 | | 0.03 | | | | | | | | 0.5 | |
| Undecavertol | A | | | | 6.75 | | | | | | | | 10 | |
| Vanilline | | | 0.4 | | | 0.12 | 0.3 | | | | | | | |
| Vernaldehyde | A | | | | 4.25 | 0.5 | | 1 | | | | | | |
| Ylang Ylang Oil | | | 0.5 | | | | 0.3 | | 0.5 | | | | | |
| GROUP A ingredients | | 4 | 12.6 | 10.7 | 27.9 | 19.3 | 18.2 | 26.7 | 10.9 | 11.6 | 13.6 | 28.9 | 20.8 | 15.2 |
| GROUP B ingredients | | 5.5 | 16.6 | 17.6 | 22.9 | 60 | 42 | 4.1 | 9.3 | 25 | 66.2 | 10.5 | 30.7 | 31.8 |
| Number of GROUP A | | 2 | 10 | 8 | 12 | 9 | 12 | 8 | 11 | 7 | 5 | 8 | 5 | 5 |
| ingredients | | | | | | | | | | | | | | |
| Number of GROUP B | | 6 | 10 | 5 | 6 | 8 | 4 | 4 | 6 | 5 | 4 | 6 | 4 | 6 |
| ingredients | | | | | | | | | | | | | | |

### Example 2—Olfactive Evaluation

Each of the perfumes described in Table 1 was admixed with an unperfumed laundry care liquid detergent comprising bio-sourced surfactants. The level of perfume in the detergent was determined empirically in order to obtain an olfactive performance that was comparable to that of a conventional, not 100% biodegradable perfume. These levels are shown in Table 2.

The mixtures were left to macerate for 3 days before further use. 35 ml of this detergent was used in a European front-loaded wash machine, loaded with 1.2 kg of cotton fabrics, consisting of three shirts, two terry towelling and two large bed sheets. The wash cycle was completed during 50 minutes at 40′C, followed by spin drying at 1000 rpm.

The odour strength and quality of the wet fabric was assessed by smelling the fabric immediately after it was taken out of the wash machine. 5 expert panellists have smelled the fabric at a distance of about 10 cm and reported both the intensity and the hedonic character of the perceived odour.

The odour strength and quality of the dry fabric was assessed by smelling the fabric 24 hours after it had been led to dry on a line. 5 expert panellists have smelled the fabric at a distance of about 10 cm and reported both the intensity and the hedonic character of the perceived odour.

The odor intensity was scored on a scale of 1-5 (1=barely noticeable, 2=weak, 3=medium, 4=strong and 5=very strong). These results are reported on Table 2.

TABLE 2
Olfactive evaluation results

| | Perfume | NEAT | | BLOOM | | WET | | DRY | | OVERALL |
|---|---|---|---|---|---|---|---|---|---|---|
| Sample | Dosage | Strength | Comments | Strength | Comments | Strength | Comments | Strength | Comments | PREFERENCE |
| BM | na | 4.2 | Floral, yacinth, | 4.3 | Fresh ozonic, | 4.2 | Yacinth | 3.2 | Floral woody | (+)(+) |
| | | | ozonic, very | | good | | flower green, | | clean | |
| | | | functional | | diffusion | | functional | | | |
| A | 1.50% | 4.1 | Clean floral | 4.2 | Cooling, very | 4.2 | Very clean, | 3.1 | Linear floral | (+)(+)(+) |
| | | | rose, | | fresh, good | | green apple, | | musc clean | |
| | | | aldehydic, | | diffusion | | rosy | | note | |
| | | | sandal wood | | | | | | | |
| E | 1.00% | 4.2 | Floral, green | 4.1 | Heavy violet | 4.2 | Violet | 3.2 | Light violet | (+) |
| | | | violette, | | | | | | | |
| | | | powdery | | | | | | | |
| F | 1.00% | 4.3 | Fruity anisic, | 4.3 | Strong fruity, | 4.3 | Fruity, anisic, | 3.1 | Peach melon | (+)(+)(+) |
| | | | bit sweet | | anisic | | sweet melon | | | |
| | | | melon | | watermelon | | | | | |
| | | | | | aspect | | | | | |
| G | 0.80% | 4.1 | Green watery | 4.3 | Good diffusion, | 4.2 | Watery anisic | 3.1 | Fresh floral | (+)(+)(+) |
| | | | anisic | | fresh anisic | | slightly rosy | | watery | |
| | | | | | watery green | | | | | |
| H | 1.00% | 4.1 | Clean aldehydic, | 4.1 | Idem neat, | 4.1 | Very clean | 3 | Very clean | (+)(+) |
| | | | ozonic impactful | | very good | | and pleasant, | | and pleasant, | |
| | | | | | | | aldehydic | | aldehydic | |
| M | 1.00% | 4.3 | Solid floral | 4.4 | Great volume, | 4.3 | Strong floral | 3.2 | Floral | (+)(+) |
| | | | rose violet | | nice, feminine | | bouquet, bit | | | |
| | | | note, natural | | | | metallic | | | |
| | | | | | | | geranium | | | |

Sample BM provides a typical clean floral odour at all the relevant stages of the laundry care application. The diffusivity and the impression of the cleanness are associated to the high levels of cyclenes and Iso E super. Agrumex, Yara yara, Radjanol and Rosacetol contribute to both diffusivity and tenacity of the odour on fabrics; Rosacetol and Yara bringing additionally a substantive floral contribution.

In Sample A, the combination of hexyl acetate, ionone-beta and Toscanol brings a clean-fruity contribution that replaces the missing cyclenes. Concomitantly, the contribution of missing Rosacetol and Yara yara is provided by a combination of Dihydrofranesal, Hydroxycitronellal, Irisone alpha and Rosalva. This example illustrates the use of a cyclene replacer, a Iso E Super replacer and a Floral replacer

In Sample E, the green violet direction is obtained by using Isoraldeine 70, reinforced with Maltyl isobutyrate and Rosalva, combined with a quinolines replacer comprising Neofolione and Cis-3-hexenyl acetate, and a Iso E Siper replacer comprising Ambrofix and Ebanol.

In Sample F, the missing clean cyclene contribution is provided by a Cyclene replacer comprising Hexal acetate, Ionone beta and Nectaryl, whereas the fruity-anisic character is provided by Peach pure and Terpenyl acetate reinforced with a quinoline replacer comprising Neofolione and Cis-3-hexenol.

Sample G illustrates the use of the Neroli replacer Orange flower ether to provide a clean, watery olfactive impression. The olfactive performance of this perfume composition is reinforced by using an unusually high level of Pinoacetaldehyde.

Sample H illustrates the use of a Floral replacer comprising Myraldyl acetate and Rosalva, in combination with Aldehyde C 11 undecylenic and Aldehyde C 11 Iso to generate a very clean aldehydic odour.

In Sample M, a floral perfume composition is provided that performs particularly well at all assessment stages. This has been achieved by combining the clean contribution of a Cyclene replacer, comprising Nectaryl, Ionone beta and unusually high levels of Hexyl acetate and Cis-3-hexenyl salicylate, with a Floral replacer comprising Myraldene, Rosalva and an unusually high level of Rose oxide. Concomitantly, a clean woody-amber background is provided by unusually high levels of Ambrettolide and Ambrofix.

In Examples A, E, F, G, H and M it was possible to obtain perfume compositions, comprising only biodegradable and renewable or partially renewable perfumery ingredients. The olfactive performance of these compositions, at all assessment stages of a laundry care application, was comparable or even better than the performance of a conventional laundry detergent perfume comprising non-biodegradable ingredients known for their intrinsic performance in the same application.

1. A biodegradable perfume composition, comprising
a) Group A ingredients selected from the group consisting of at least two biodegradable ingredients selected from 3,8,8,11a-tetramethyldodecahydro-1H-3,5a-epoxynaphtho[2,1-c]oxepine; 1-(2,2,6-trimethylcyclohexyl)hexan-3-ol; (E)-3,3-dimethyl-5-(2,2,3-trimethyl-3-cyclopenten-1-yl)-4-penten-2-ol; (E)-3-methyl-5-(2,2,3-trimethylcyclopent-3-en-1-yl)pent-4-en-2-ol; (1S,2R,5S,7R,8R)-2,6,6,8-tetramethyltricyclo[5.3.1.01,5]undecan-8-ol; 4-methoxy-2,2,7,7-tetramethyltricyclo[6.2.1.01,6]undec-5-ene; 1′,1′,5′,5′-Tetramethylhexahydro-spiro[1,3-dioxolane-2,8′(5′H)-2H-2,4a-methanonaphthalene]; (E)-4-methyldec-3-en-5-ol; 1-phenylethyl acetate; (2-methoxyethyl)benzene; (Z)-hex-3-enyl acetate; (Z)-hex-3-en-1-yl butanoate; 4-(4-methylpent-3-en-1-yl)cyclohex-3-enecarbaldehyde; (4-(4-methylpent-3-en-1-yl)cyclohex-3-en-1-yl)methyl acetate; dec-9-en-1-ol; (4E)-4,8-dimethyldeca-4,9-dienal; (E)-1-(2,6,6-trimethylcyclohex-2-en-1-yl)but-2-en-1-one; (E)-1-(2,6,6-trimethylcyclohexa-1,3-dien-1-yl)but-2-en-1-one; 5-methyl-5-phenylhexan-3-one; 1-methyl-4-(4-methylpentyl)cyclohex-3-enecarbaldehyde; 1-methyl-4-(4-methylpent-3-en-1-yl)cyclohex-3-enecarbaldehyde; 7-hydroxy-3,7-dimethyloctanal; 3-(4-(2-methylpropyl)-2-methylphenyl)propanal; (E)-methyl non-2-enoate; 1-(5,5-dimethylcyclohex-1-en-1-yl)pent-4-en-1-one; 2-cyclohexylhepta-1,6-dien-3-one; (Z)-3-methylcyclotetradec-5-enone; 2-ethoxy-4-methylphenol; 1-(cyclopropylmethyl)-4-methoxybenzene; 2-methyl-4-oxo-4H-pyran-3-yl 2-methylpropanoate; 2,4,7-Trimethyl-6-octen-1-ol; (2-benzyl-1,3-dioxolan-4-yl)methanol; (2-(1-propoxyethoxy)ethyl)benzene; 3-phenylbutanal; (Z)-3,7,11-trimethyldodeca-6,10-dienal; 7-methyl-3-methylideneoct-6-enal; hexanal; (E)-hex-2-enal; 3-(4-propan-2-ylcyclohexen-1-yl)propanal; 4-methyl-2-(2-methylprop-1-en-1-yl)tetrahydro-2H-pyran; 1,7-dioxacycloheptadecan-8-one; (Z)-oxacycloheptadec-10-en-2-one; 3a,6,6,9a-tetramethyl-2,4,5,5a,7,8,9,9b-octahydro-1H-benzo[e][1]benzofuran; 4-(2-methoxypropan-2-yl)-1-methylcyclohexene; (1S,2S,4S)-2-methoxy-1,7,7-trimethylbicyclo[2.2.1]heptane; 4,7-dimethyloct-6-en-3-one; 6,8-dimethylnonan-2-ol; (1S)-1,7,7-trimethylbicyclo[2.2.1]heptan-2-yl 2-methylpropanoate; 2-cyclohexylhepta-1,6-dien-3-one; 2-methyl-4-oxo-4H-pyran-3-yl 2-methylpropanoate; ethyl (Z)-2-acetyl-4-methyltridec-2-enoate; Akigalawood, or mixtures thereof, and
b) Optionally Group B ingredients selected from the group consisting of (2-benzyl-1,3-dioxolan-4-yl)methanol; (2-(1-propoxyethoxy)ethyl)benzene; decanal; 2-methyldecanal; undec-10-enal; undecanal; dodecanal; 2-methylundecanal; heptanal; octanal; 3,5,5-trimethylhexanal; nonanal; (E)-non-2-enal; prop-2-enyl 2-(3-methylbutoxy)acetate; 3a,6,6,9a-tetramethyl-2,4,5,5a,7,8,9,9b-octahydro-1H-benzo[e][1]benzofuran; pentyl 2-hydroxybenzoate; phenylethyl 2-methylbutanoate; (2-(isopentyloxy)ethyl)benzene; (4Z)-4,11,11-trimethyl-8-methylenebicyclo(7.2.0)undec-4-ene; (1S,8aR)-1,4,4,6-tetramethyl-2,3,3a,4,5,8-hexahydro-1H-5,8a-methanoazulene; ((1S,8aR)-1,4,4-trimethyl-2,3,3a,4,5,8-hexahydro-1H-5,8a-methanoazulen-6-yl)methanol; (Z)-hex-3-en-1-yl 2-hydroxybenzoate; 3-(4-isopropylphenyl)-2-methylpropanal; cyclohexyl 2-hydroxybenzoate; 6-pentyltetrahydro-2H-pyran-2-one; 5-hexyloxolan-2-one; 3,7-dimethylocta-1,6-diene; 2-methyl-1-phenylpropan-2-ol; 2-methyl-1-phenylpropan-2-yl acetate; 2-methyl-4-phenylbutan-2-yl acetate; 2-methyl-1-phenylpropan-2-ol; 2-methyl-1-phenylpropan-2-yl acetate; 6-heptyltetrahydro-2H-pyran-2-one; 5-octyloxolan-2-one; 3-O-[1-(3,3-dimethylcyclohexyl)ethyl]1-O-ethyl propanedioate; 1,4-dioxacycloheptadecane-5,17-dione; cyclopentadecanone; (3E)-oxacyclohexadec-3-en-2-one; (E)-oxacyclohexadec-12-en-2-one; methyl 3-oxo-2-pentylcyclopentaneacetate; 6-ethyloxan-2-one; 5-propyloxolan-2-one; 1-oxacycloheptadecan-2-one; hexyl acetate; 5-ethyloxolan-2-one; hexyl 2-hydroxybenzoate; (E)-4-(2,6,6-trimethyl-1-cyclohex-2-enyl)but-3-en-2-one; (E)-4-(2,6,6-trimethylcyclohex-1-en-1-yl)but-3-en-2-one; (E)-3-methyl-4-(2,6,6-trimethylcyclohex-2-en-1-yl)but-3-en-2-one; (E)-4-(2,6,6-trimethylcyclohex-2-en-1-yl)but-3-en-2-one; cyclohexadecanone; (E)-3-methyl-4-(2,6,6-trimethyl-cyclohex-2-en-1-yl)but-3-en-2-one; (Z)-6-(pent-2-en-1-yl)tetrahydro-2H-pyran-2-one; (Z)-5-(hex-3-en-1-yl)-5-methyloxolan-2-one; (E)-6-(pent-3-en-1-yl)-tetrahydro-2H-pyran-2-one; (4Z)-hept-4-en-2-yl 2-hydroxybenzoate; 3-methyl-5-phenylpentanal; 3-methyl-5-phenylpentan-1-ol; 5-hexyl-5-methyloxolan-2-one; 3-methylcyclopentadecanone; 2-(2-(4-methylcyclohex-3-en-1-yl)propyl)-cyclopentan-1-one; 5-pentyloxolan-2-one; 6-propyltetrahydro-2H-pyran-2-one; 5-butyloxolan-2-one; 1,1-dimethoxycyclododecane; 5-heptyldihydrofuran-2(3H)-one; 2-methyl-5-propan-2-ylcyclohexa-1,3-diene; 2-phenylethanol; 2-phenylethyl acetate; 2-phenylethyl butanoate; 2-phenylethyl 3-phenylprop-2-enoate; 2-phenylethyl formate; 2-phenylethyl 2-methylpropanoate; 2-phenylethyl 3-methylbutanoate; 2-phenylethyl acetate; 3-(6,6-dimethylbicyclo[3.1.1]hept-2-en-2-yl)propanal; 4-(4-hydroxyphenyl)butan-2-one; (1-oxopropoxy)-acetic acid, 1-(3,3-dimethyl cyclohexyl)ethyl ester; 6,6-dimethylspiro[bicyclo[3.1.1]heptane-2,2′-oxirane]; 3-methyl-5-(2,2,3-trimethylcyclopent-3-en-1-yl)pentan-2-ol; oxacyclohexadecan-2-one; 5-methyloxolan-2-one; 2-(2-hydroxypropan-2-yl)-5-methylcyclohexanol; Patchouli oil; Clove oil; Geranium oil; Orange terpenes; Eucalyptus oil; Badiane oil; Lavandin oil; Mint oil; Nutmeg oil; or mixtures thereof;
and which is free or substantially free of any of the following non-biodegradable ingredient, referred to as Group C ingredients:
i. Ingredients comprising a fully or partially hydrogenated methano-indene moiety;
ii. Ingredients comprising two or more fused-ring moieties selected from 6-butan-2-yl-quinoline; 5-isopropylquinoline; decahydro-2,2,6,6,7,8,8-heptamethyl indenofuran; 1,3,4,5,6,7-hexahydro-1,1,5,5-pentamethyl-2H-2,4a-methanonaphthalene-8-ethanol; (4aR,5R,7aS,9R)-octahydro-2,2,5,8,8,9a-hexamethyl-4H-4a,9-methanoazuleno[5,6-d]-1,3-dioxole; 8,8-dimethyl-1,2,3,4,5,6,7,8-octahydronaphthalene-2-carbaldehyde; 7-isopentyl-2H-benzo[b][1,4]dioxepin-3(4H)-one; (1R,2S,4R)-2′-isopropyl-1,7,7-trimethylspiro[bicyclo[2.2.1]heptane-2,4′-[1,3]dioxane]; 8-methyl-1,5-benzodioxepin-3-one; 1,1,2,3,3-pentamethyl-2,3,6,7-tetrahydro-1H-inden-4(5H)-one; 1-(6-tert-butyl-1,1-dimethyl-2,3-dihydroinden-4-yl)ethanone; 1-(3,5,5,6,8,8-hexamethyl-5,6,7,8-tetrahydronaphthalen-2-yl)ethanone; 4,6,6,7,8,8-hexamethyl-1,3,4,6,7,8-hexahydrocyclopenta-[g]isochromene; 1-(1,2,8,8-tetramethyl-1,2,3,4,5,6,7,8-octahydro-naphthalen-2-yl)ethanone; 4,4a,5,9b-tetrahydroindeno[1,2-d][1,3]dioxine; 1-(2,3,8,8-tetramethyl-1,2,3,4,5,6,7,8-octahydro-naphthalen-2-yl)ethanone; 2,2,7,7-tetramethyltricyclo[-6.2.1.01,6]undecan-5-one; 2,4-dimethyl-4,4a,5,9b-tetrahydroindeno[1,2-d][1,3]dioxine; 1-((1S,8aS)-1,4,4,6-tetramethyl-2,3,3a,4,5,8-hexahydro-1H-5,8a-methanoazulen-7-yl)ethanone; 1a,3,3,4,6,6-hexamethyl-1a,2,3,4,5,6,7,7a-octahydronaphtho[2,3-b]oxirene; 1-(3-methyl-benzofuran-2-yl)ethanone; 2,4-dimethyl-2-(5,5,8,8-tetramethyl-5,6,7,8-tetrahydronaphthalen-2-yl)-1,3-dioxolane; 2,4a,5,8a-tetramethyl-1,2,3,4,4a,7,8,8a-octahydronaphthalen-1-yl formate; (8aR)-4,4,8,8-tetramethylhexahydro-1H-3,8a-methanonaphthalen-5(6H)-one; (4aS,8aR)-7-methyloctahydro-1,4-methanonaphthalen-6(2H)-one; 6-(sec-butyl)quinoline; (2R,8aS)-3′,6-dimethyl-3,4,4a,5,8,8a-hexahydro-1H-spiro[1,4-methanonaphthalene-2,2′-oxirane]; and 3,7-dimethyloctan-3-ol; and 3,6,6,7a-tetramethyloctahydro-2H-2a,7-methanoazuleno[5,6-b]oxirene;
iii. Ingredients comprising a cyclohexylidene benzoacetonitrile moiety;
iv. Ingredients comprising an aromatic ring substituted by an aldehyde moiety having a secondary carbon atom in alpha position of the aldehyde group;
v. Ingredients comprising one or more bridged cycles selected from bicyclo[2.2.2]oct-5-ene-2-carboxaldehyde; 3-((1R,2S,4R,6R)-5,5,6-trimethylbicyclo[2.2.1]heptan-2-yl)-cyclohexanol; alpha-cedrene epoxide; methyl-4(or 1)-isopropyl-1(or 4)-methylbicyclo[2.2.2]oct-5-ene-2-carboxylate; 1-methyl-4-(2,2,3-trimethylcyclopentyl)-2-oxabicyclo[2.2.2]octane; 6-ethylidenebicyclo-[2.2.1]hept-2-yl propan-2-yl ether; and (2S)-ethyl isopropylbicyclo[2.2.1]hept-5-ene-2-carboxylate;
vi. Ingredients comprising a sterically hindered conjugated carbonyl moiety;
vii. Ingredients comprising a ketal or an acetal moiety selected from 6,6-dimethoxy-2,5,5-trimethylhex-2-ene; (1,1-diethoxypropan-2-yl)benzene; 2-butyl-4,4,6-trimethyl-1,3-dioxane; 2,4,6-trimethyl-4-phenyl-1,3-dioxane; (ethoxymethoxy)cyclododecane; ethyl 2-(2-methyl-1,3-dioxolan-2-yl)acetate; (2-(1-ethoxyethoxy)ethyl)-benzene; (2,2-dimethoxyethyl)benzene; 2-(cyclohexylmethyl)-4,4,6-trimethyl-1,3-dioxane; or
viii. An ingredient selected from N-ethyl-N-(m-tolyl)propionamide; 1-((2-(tert-butyl)cyclohexyl)oxy)butan-2-ol; 3,5-diethyl-2,5-dimethylcyclohex-2-enone; (2-methyl-5-prop-1-en-2-ylcyclohexyl) acetate; 2-benzyl-2-methylbut-3-enenitrile; 2-(tert-pentyl)cyclohexyl acetate; ethyl 2,6,6-trimethylcyclohexa-1,3-diene-1-carboxylate; allyl 2-(cyclohexyloxy)acetate; methyl 1,4-dimethylcyclohexanecarboxylate; 3-(4-ethylphenyl)-2,2-dimethylpropanenitrile; 2-(tert-butyl)cyclohexyl ethyl carbonate; ethyl 2-(2,4-dimethyl-1,3-dioxolan-2-yl)acetate; N,2-dimethyl-N-phenylbutanamide; ethyl 2-ethyl-6,6-dimethyl-cyclohex-2-enecarboxylate; 2-butyl-4,6-dimethyl-3,6-dihydro-2H-pyran; [2-[1-(3,3-dimethylcyclohexyl)ethoxy]-2-methylpropyl]propanoate; (1-ethynylcyclohexyl) acetate; 3,7-dimethyloctanenitrile; (1S,2S,4S)-2-methoxy-1,7,7-trimethyl-bicyclo[2.2.1]heptane; 2,4,6-trimethylcyclohex-3-ene-carbaldehyde; 2-methyl-3-(4-methylphenyl)propanal; (1-methyl-2-((1,2,2-trimethylbicyclo[3.1.0]hexan-3-yl)methyl)-cyclopropyl)-methanol; 4-(1-ethoxyethenyl)-3,3,5,5-tetramethylcyclohexan-1-one; 2,2-dimethyl-4-phenylpentanenitrile; (Z)-3,4,5,6,6-pentamethylhept-3-en-2-one; 3,4,5,6,6-pentamethylheptan-2-ol; (3E,6E)-2,4,4,7-tetramethylnona-6,8-dien-3-one oxime; 2,2,6-trimethyl-6-vinyltetrahydro-2H-pyran; 3-methyl-4-(2,2,6-trimethylcyclohexyl)butan-2-ol; 2,2-dimethyl-3-(m-tolyl)propan-1-ol; 4-[(3E)-4,8-dimethylnona-3,7-dienyl]pyridine; 1-(3,5,6-trimethyl-1-cyclohex-3-enyl)ethanone; 2-methoxy-1,1′-biphenyl; 3-cyclohexyl-2,2-dimethylpropan-1-ol; 1-(4-propan-2-ylcyclohexyl)ethanol; 10-isopropyl-2,7-dimethyl-1-oxaspiro[4.5]-deca-3,6-diene; 4-(tert-pentyl)cyclo-hexanone; methoxycyclododecane; 2-ethyl-N-methyl-N-(m-tolyl)butanamide; 2-methyl-4-methylene-6-phenyltetrahydro-2H-pyran; Ethyl-2,3,6-trimethylcyclohexyl carbonate; 2,4-dimethyl-4-phenyl-tetrahydrofuran; 2,2,2-trichloro-1-phenylethyl acetate; 1-(3,3-dimethylcyclohexyl)ethyl acetate; 3-(2-methylpropyl)-1-methylcyclohexanol; 2-(1-(3,3-dimethylcyclohexyl)ethoxy)-2-methylpropyl cyclopropanecarboxylate; (E)-5-methylheptan-3-one oxime; (4E)-4-[(2Z)-But-2-en-1-ylidene]-3,5,5-trimethylcyclohex-2-en-1-one (mixture of isomers); ethyl (1R,6S)-2,2,6-trimethylcyclohexane-1-carboxylate; 1-((2E,5Z,9Z)-2,7,8-trimethylcyclododeca-2,5,9-trien-1-yl)ethanone; 4a,5-dimethyl-3-prop-1-en-2-yl-2,3,4,5,6,7-hexahydro-1H-naphthalene; 2,2,5-trimethyl-5-pentylcyclopentanone; 4-methyl-4-phenylpentan-2-yl acetate; and (2R,5R,8S)-4,4,8-trimethyltricyclo[6.3.1.02,5]dodecan-1-yl acetate.

2. The perfume composition according to claim 1, wherein at least 50 wt.-% of the carbon atoms comprised in the perfume composition are derived from renewable feedstocks.

3. The perfume composition according to claim 1, wherein (E)-4-methyldec-3-en-5-ol, at a level of from 5 wt.-% to 25 wt.-%, is combined with at least two ingredients selected from 1-(cyclopropylmethyl)-4-methoxybenzene at a level of from 0.2 wt.-% to 0.5 wt.-%, (E)-4-(2,6,6-trimethylcyclohex-1-en-1-yl)but-3-en-2-one at a level of from 5 wt.-% to 20 wt.-%, 2-(2-(4-methylcyclohex-3-en-1-yl)propyl)cyclopentan-1-one at a level of from 5 to 40 wt.-%, hexyl acetate at a level of from 0.5 wt.-% to 5 wt.-%, pentyl 2-hydroxybenzoate at a level of from 5 wt.-% to 15 wt.-%, and (Z)-hex-3-en-1-yl 2-hydroxybenzoate at a level of from 5 wt.-% to 15 wt.-%, based on the total weight of the perfume composition.

4. The perfume composition according to claim 1, comprising at least two ingredients selected from 1-phenylethyl acetate at a level of from 5 wt.-% to 15 wt.-%, (2-methoxyethyl)benzene at a level of from 0.3 wt.-% to 5 wt.-%, hexanal at a level of from 0.5 wt.-% to 2 wt.-%, 3-phenylbutanal at a level of from 0.3 wt.-% to 2 wt.-%, (E)-2-Hexenal-2-trans at a level of from 0.1 wt.-% to 1 wt.-%, (Z)-hex-3-en-1-olate a level of from 1 wt.-% to 2 wt.-%, (Z)-hex-3-en-1-ylacetate at a level of from 0.3 wt.-% to 2 wt.-%, prop-2-enyl 2-(3-methylbutoxy) at a level of from 1 wt.-% to 5 wt.-%, 1-(5,5-dimethylcyclohex-1-en-1-yl)pent-4-en-1-one at a level of from 0.2 wt.-%, to 1 wt.-%, (E)-methyl non-2-enoate at a level of from 1 wt.-% to 10 wt.-%, and 2-cyclohexylhepta-1,6-dien-3-one at a level of 0.1 wt.-% to 0.3 wt.-%, based on the total weight of the perfume composition.

5. The perfume composition according to claim 1, comprising at least two ingredients selected from 1-(2,2,6-trimethylcyclohexyl)hexan-3-ol at a level of from 2 wt.-% to 4 wt.-%, (E)-3,3-dimethyl-5-(2,2,3-trimethyl-3-cyclopenten-1-yl)-4-penten-2-ol at a level of from 2 wt.-% to 4 wt.-%, (1S,2R,5S,7R,8R)-2,6,6,8-tetramethyltricyclo[5.3.1.01,5]undecan-8-ol at a level of from 10 to 25 wt.-%, 3a,6,6,9a-tetramethyl-2,4,5,5a,7,8,9,9b-octahydro-1H-benzo[e][1]benzofuran at a level of from 1 wt.-% to 5 wt.-%, Akigalawood at a level of 0.2 to 2 wt.-%, 1-methyl-4-(4-methylpent-3-en-1-yl)cyclohex-3-enecarbaldehyde at a level of from 1 wt.-% to 10 wt.-%, and (E)-3-methyl-5-(2,2,3-trimethylcyclopent-3-en-1-yl)pent-4-en-2-ol at a level of from 1 wt.-% to 5 wt.-%, based on the total weight of the perfume composition.

6. The perfume composition according to claim 1 comprising 4-(2-methoxypropan-2-yl)-1-methylcyclohexene at a level of from 0.3 to 2 wt.-%, based on the total weight of the perfume composition.

7. The perfume composition according to claim 1, comprising at least two ingredients selected from 4-(4-methylpent-3-en-1-yl)cyclohex-3-enecarbaldehyde at a level of from 5 wt.-% to 15 wt.-%, (4-(4-methylpent-3-en-1-yl)cyclohex-3-en-1-yl)methyl acetate at a level of from 1 wt.-% to 10 wt.-%, dec-9-en-1-ol at a level of from 0.2 wt.-% to 2 wt.-%, 1-methyl-4-(4-methylpentyl)cyclohex-3-enecarbaldehyde at a level of from 1 wt.-% to 10 wt.-%, 1-methyl-4-(4-methylpent-3-en-1-yl)cyclohex-3-enecarbaldehyde at a level of from 1 wt.-% to 10 wt.-%, 7-hydroxy-3,7-dimethyloctanal at a level of from 1 to 10 wt.-%, 3-(4-(2-methylpropyl)-2-methylphenyl)propanal at a level of from 1 wt.-% to 15 wt.-%, 4-methyl-2-(2-methylprop-1-en-1-yl)tetrahydro-2H-pyran at a level of from 0.1 wt.-% to 5 wt.-% and (E)-4-methyldec-3-en-5-ol at a level of 10 wt.-% to 25 wt.-%, based on the total weight of the perfume composition.

8. The perfume composition according to claim 1, comprising at least two ingredients selected from (E)-3-methyl-4-(2,6,6-trimethylcyclohex-2-en-1-yl)but-3-en-2-one at a level of from 10 wt.-% to 50 wt.-%, (E)-4-(2,6,6-trimethylcyclohex-2-en-1-yl)but-3-en-2-one at a level of from 10 wt.-% to 50 wt.-%, (E)-1-(2,6,6-trimethylcyclohex-2-en-1-yl)but-2-en-1-one at a level of from 0.1 wt.-% to 1 wt.-%, 4-(4-hydroxyphenyl)butan-2-one at a level of from 5 wt.-% to 25 wt.-%, and 2-methyl-4-oxo-4H-pyran-3-yl 2-methylpropanoate at a level of from 0.1 wt.-% to 1 wt.-%, based on the total weight of perfume ingredients in the composition.

9. The perfume composition according to claim 1, comprising one or more ingredients selected from Pomelol at a level of from 5 to 25 wt.-%.

10. The perfume composition according to claim 1, comprising one or more ingredients selected from 2-ethoxy-4-methylphenol at a level of from 0.1 wt.-% to 1 wt.-%, (1S,2S,4S)-2-methoxy-1,7,7-trimethylbicyclo[2.2.1]heptane at a level of from 0.5 wt.-% to 5 wt.-%, and 1-(cyclopropylmethyl)-4-methoxybenzene at a level of from 0.1 wt.-% to 0.5 wt.-%, based on the total weight of the perfume composition.

11. A method for obtaining a biodegradable perfume composition, the method comprising the step of mixing:
a) From 8 wt.-% to 40 wt.-% of Group A ingredients;
b) From 0 wt.-% to 92 wt.-% of Group B ingredients; and
c) From 0 wt.-% to 92 wt.-% of one or more ingredients that are different from Group A and Group B ingredients to complete to 100%.

12. A method of enhancing the olfactive performance of a biodegradable perfume composition, the method comprising adding at least two Group A ingredients and one or more Group B ingredients to the biodegradable perfume composition.

13. A consumer product comprising a non-encapsulated perfume composition according to claim 1.

14. The consumer product according to claim 13, comprising at least one bio-sourced surfactant from alkyl amino acid esters, amino acid amides, polyglycerides, polyglyceryl fatty acid, or sugar amide surfactants.

15. The consumer product according to claim 14, comprising rhamnolipids.

16. The consumer product according to claim 13 comprising from 0.1 to 5 wt.-% of the non-encapsulated perfume composition according to claim 1.

17. The perfume composition according to claim 2, wherein at least 90 wt.-% of the carbon atoms comprised in the perfume composition are derived from renewable feedstocks.

18. The consumer product according to claim 13, wherein the consumer product is a laundry care product.
